(19) United States
(12) Patent Application Publication
(10) Pub. No.: US 2012/0177003 A1
(43) Pub. Date: Jul. 12, 2012

(54) System and Method for Single Radio Handovers

(75) Inventors: Hinghung Anthony Chan, Plano, TX (US); Jung Hoon Jee, Daejeon (KR); Chang Min Park, Daejeon (KR); Yoon Young An, Daejeon (KR)

(73) Assignee: FutureWei Technologies, Inc., Plano, TX (US)

(21) Appl. No.: 13/104,920

(22) Filed: May 10, 2011

Related U.S. Application Data
(60) Provisional application No. 61/431,698, filed on Jan. 11, 2011.
(60) Provisional application No. 61/452,913, filed on Mar. 15, 2011.

(51) Int. Cl. H04W 36/34; H04W 48/16; H04W 88/16

(52) U.S. Cl. 370/331

(57) ABSTRACT

A system and method for single radio handovers are provided. A method for controller operations includes receiving a first message from a mobile node. The first message is transported in a first network. The method also includes transforming the first message into a second message. The second message is to be transported in a second network. The method further includes sending the second message to a point of access in the second network. The point of access is a target point of access for the mobile node in a single radio handover.

This application claims the benefit of U.S. Provisional Application No. 61/431,698, filed on Jan. 11, 2011, entitled “System and Method for Radio Handover,” and U.S. Provisional Application No. 61/452,913, filed on Mar. 15, 2011, entitled “System and Method for Single Radio Handover Across Different Networks,” which applications are hereby incorporated herein by reference.

### TECHNICAL FIELD

The present invention relates generally to digital communications, and more particularly to a system and method for single radio handovers.

### BACKGROUND

The drive for wireless communications is to allow for greater levels of roaming and allow seamless roaming. Myriad issues, such as hand-off between providers, authentication, communication system capabilities and limitations, become increasingly important when roaming, particularly when global roaming is contemplated.

When a mobile node (also commonly referred to as a mobile station, subscriber, user, terminal, User Equipment (UE), and so forth) moves from an area covered by one network and enters another area covered by another network the call must be transferred to the second network without dropping the connection or loosing packets. In cellular telecommunications, the term handover or handoff refers to the process of transferring an ongoing call or data session from one channel connected to the core network to another. This function can be referred to as handover with fast mobility. The term handover or handoff may also apply to when a mobile node changes from one channel connected to the core network via a first communications controller (also commonly referred to as a base station, controller, base terminal station, NodeB, enhanced NodeB, and so on) to a second communications controller. Similarly, when a mobile node is powered on in a new location served by a different network than the immediately preceding network used by the mobile node, the wireless communications network must recognize the change in location of the mobile node and direct to the new network the information destined to the mobile node. This can be referred to as handover with slow mobility.

As more different types of access networks become available, a goal of equipment manufacturers has been to produce a single mobile node that is capable of operating in multiple access interfaces. These mobile nodes may commonly be referred to as a multi-mode mobile node, multi-mode phone, global phone, or so forth. In order to support multiple access networks, these mobile nodes may have multiple transmit radios to allow for simultaneous access to more than one access network.

### SUMMARY OF THE INVENTION

These and other problems are generally solved or circumvented, and technical advantages are generally achieved, by example embodiments of the present invention which provide a system and method for single radio handovers.

In accordance with an example embodiment of the present invention, a method for controller operations is provided. The method includes receiving a first message from a mobile node. The first message is transported in a first network. The method also includes transforming the first message into a second message. The second message is to be transported in a second network. The method further includes sending the second message to a point of access in the second network. The point of access is a target point of access for the mobile node in a single radio handover.

In accordance with another example embodiment of the present invention, a controller is provided. The controller includes a receiver, a transformation unit coupled to the receiver, and a transmitter coupled to the transformation unit. The receiver receives a first message from a mobile node, where the first message is transported in a first network. The transformation unit operates as a gateway, and transforms the first message into a second message, where the second message is to be transported in a second network. The transmitter transmits the second message to a point of access in the second network, where the point of access is a target point of access for the mobile node in a single radio handover.

In accordance with another example embodiment of the present invention, a controller is provided. The controller includes a receiver, a gateway coupled to the receiver, a proxy unit coupled to the receiver, and a transmitter coupled to the gateway and to the proxy unit. The receiver receives a first message from a mobile node, where the first message is transported in a first network. The gateway transforms the first message into a second message, where the second message is to be transported in a second network. The proxy unit processes the second message for transport in the second network, and the transmitter sends the second message on the second network.

In accordance with another example embodiment of the present invention, a controller is provided. The controller includes a receiver, a gateway coupled to the receiver, a proxy unit coupled to the receiver, an interoperability unit coupled to the receiver, and a transmitter coupled to the gateway and to the proxy unit. The receiver receives a first message from a mobile node, where the first message is transported in a first network. The gateway transforms the first message into a second message, where the second message is to be transported in a second network. The proxy unit processes the second message for transport in the second network, the interoperability unit authenticates messages, and the transmitter sends the second message on the second network.

In accordance with another example embodiment of the present invention, a method for mobile node operations is provided. The method performing a network discovery, making a handover decision based on results from the network discovery, preparing for a handover, and executing the handover. The preparing is performed through an intermediary and uses a single communications link.

In accordance with another example embodiment of the present invention, a communications network is provided. The communications network includes a point of access, and a control gateway coupled to the point of access. The point of access allows a mobile node to connect to the communications network and access services of the communications network. The control gateway serves as an intermediary for the mobile node to allow the communications node to communicate with the point of access in order to initiate a single radio handover with the point of access while the mobile node is connected to a source point of access of a source communications network. Where communications between the mobile node and the point of access is over a communications link in the source communications network.

One advantage disclosed herein is that the techniques described herein enable single radio handovers between a wide range of access networks rather than limiting the single radio handovers to be between a specific set of access networks. Therefore, the flexibility in supporting single radio handovers, especially for newly developed access networks is increased.

A further advantage of exemplary embodiments is that handover signaling preparation with a target network through a source network is performed prior to execution of the handover. Therefore, handover delay is reduced. Furthermore, by preparing the handover signaling prior to actually attempting to execute the handover increases the likelihood of the handover succeeding.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1a illustrates an example communications system according to example embodiments described herein;

FIG. 1b illustrates an example communications flow from a MN to network entities in a target network according to example embodiments described herein;

FIG. 1c illustrates an example communications flow from network entities in a target network to a MN according to example embodiments described herein;

FIG. 2 illustrates an example communications protocol layer view of a communications system according to example embodiments described herein;

FIG. 3 illustrates an example a communications protocol layer view of a communications system, wherein a MI protocol is implemented at the target network according to example embodiments described herein;

FIG. 4a illustrates an example diagram of interaction between various entities in a communications system that is performing a single radio handover according to example embodiments described herein;

FIG. 4b illustrates an example flow diagram of operations in a single radio handover according to example embodiments described herein;

FIG. 4c illustrates an example flow diagram of MN operations in a single radio handover according to example embodiments described herein;

FIG. 4d illustrates an example flow diagram of source POA operations in a single radio handover according to example embodiments described herein;

FIG. 4e illustrates an example flow diagram of C-GW operations in a single radio handover according to example embodiments described herein;

FIG. 4f illustrates an example flow diagram of target POA operations in a single radio handover according to example embodiments described herein;

FIG. 5 illustrates an example communications system, wherein a single radio handover between a WLAN AN and a WiMAX network occurs according to example embodiments described herein;

FIG. 6a illustrates an example communications protocol layer view of a communications system, wherein a single radio handover between a WLAN AN and a WiMAX network occurs, and wherein an R6 interface is implemented at the target network according to example embodiments described herein;

FIG. 6b illustrates an example communications protocol layer view of a communications system, wherein a single radio handover between a WLAN AN and a WiMAX network occurs, and wherein a MI protocol is implemented at the target network according to example embodiments described herein;

FIG. 7 illustrates an example communications protocol layer view of a communications system, wherein a single radio handover between a WLAN AN and a WiMAX network occurs, and wherein an Rx interface is implemented at the source network according to example embodiments described herein;

FIG. 8 illustrates an example communications system, wherein a single radio handover between a 3GPP LTE network and a WiMAX network occurs according to example embodiments described herein;

FIG. 9a illustrates an example communications protocol layer view of a communications system, wherein a single radio handover between a 3GPP LTE network and a WiMAX network occurs, and wherein an R6 interface is implemented at the target network according to example embodiments described herein;

FIG. 9b illustrates an example communications protocol layer view of a communications system, wherein a single radio handover between a 3GPP LTE network and a WiMAX network occurs, and wherein a MI protocol is implemented at the target network according to example embodiments described herein;

FIG. 10 illustrates an example communications protocol layer view of a communications system, wherein a single radio handover between a 3GPP LTE network and a WiMAX network occurs, and wherein an R9 interface is implemented at the source network according to example embodiments described herein;

FIG. 11 illustrates an example communications system, wherein a single radio handover between a WiMAX network and a WLAN AN occurs according to example embodiments described herein;

FIG. 12a illustrates an example communications protocol layer view of a communications system, wherein a single radio handover between a WiMAX network and a WLAN AN occurs, and wherein a W3 interface is implemented at the target network according to example embodiments described herein;

FIG. 12b illustrates an example communications protocol layer view of a communications system, wherein a single radio handover between a WiMAX network and a WLAN AN occurs, and wherein a MI protocol is implemented at the target network according to example embodiments described herein;

FIG. 13 illustrates an example communications protocol layer view of a communications system, wherein a single radio handover between a WiMAX network and a WLAN AN occurs, and wherein an Ry interface is implemented at the source network according to example embodiments described herein;

FIG. 14 illustrates an example communications system, wherein a single radio handover between a WiMAX network and a 3GPP LTE network occurs according to example embodiments described herein;

FIG. 15a illustrates an example communications protocol layer view of a communications system, wherein a single radio handover between a WiMAX network and a 3GPP LTE network occurs, and wherein a 3GPP LTE defined interface is implemented at the target network according to example embodiments described herein;

FIG. 15b illustrates an example communications protocol layer view of a communications system, wherein a single radio handover between a WiMAX network and a 3GPP LTE network occurs, and wherein a MI protocol is implemented at the target network according to example embodiments described herein;

FIG. 16a illustrates an example communications protocol layer view of a communications system, wherein a single radio handover between a WiMAX network and a 3GPP LTE network occurs, and wherein an S2a interface is implemented at the source network according to example embodiments described herein;

FIG. 16b illustrates an example communications protocol layer view of a communications system, wherein a single radio handover between a WiMAX network and a 3GPP LTE network occurs, and wherein an S2a interface is implemented at the source network according to example embodiments described herein;

FIG. 17 illustrates an example communications system, wherein a single radio handover between a WLAN AN and a 3GPP LTE network occurs according to example embodiments described herein;

FIG. 18a illustrates an example communications protocol layer view of a communications system, wherein a single radio handover between a WiMAX network and a 3GPP LTE network occurs, and wherein an L2 interface is implemented at the target network according to example embodiments described herein;

FIG. 18b illustrates an example communications protocol layer view of a communications system, wherein a single radio handover between a WiMAX network and a 3GPP LTE network occurs, and wherein a MI protocol is implemented at the target network according to example embodiments described herein;

FIG. 19a illustrates an example communications protocol layer view of a communications system, wherein a single radio handover between a WiMAX network and a 3GPP LTE network occurs, and wherein an S2c interface is implemented at the source network according to example embodiments described herein;

FIG. 19b illustrates an example communications protocol layer view of a communications system, wherein a single radio handover between a WiMAX network and a 3GPP LTE network occurs, and wherein an SWn interface is implemented at the source network according to example embodiments described herein;

FIG. 20 provides an example communications device according to example embodiments described herein;

FIG. 21 illustrates an example C-GW for a WiMAX ASN according to example embodiments described herein;

FIG. 22 illustrates an example C-GW for a WLAN AN according to example embodiments described herein; and

FIG. 23 illustrates an example C-GW for a 3GPP LTE network according to example embodiments described herein.

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a communications system with multiple access networks, such as The Third Generation Partnership Project (3GPP) Long Term Evolution (LTE), 3GPP LTE-Advanced, WiMAX, IEEE 802.16, WLAN, WiFi, and so forth. The invention may also be applied, however, to future access networks.

Generally, in a handover involving a mobile node with a source network and a target network, the mobile node may have at least two radios turned on. A source radio may be tuned on the source network and a target radio that may be tuned on the target network. The mobile node may then perform handover preparation with the source network and the target network through the source radio and the target radio, and then execute the handover. An advantage of having active interfaces with both the source network and the target network is that handover delay may be reduced. Another advantage may be that handover reliability may be enhanced.

In a single radio handover, a single radio is used to perform the handover involving the mobile node and the source network and the target network. All handover preparation and the execution of the handover occur using the single radio. The use of a single radio results in lower peak power consumption since only one radio (instead of two radios) is turned on. However, using a single radio for accessing both the source network and the target network may result in greater complexity in radio frequency (RF) signal filtering. Furthermore, lacking an interface with the target network to perform signaling with the target network may result in an extended handover delay, as well as, decreased handover reliability.

Most existing handover techniques are limited to specific access interfaces, while a media independent handover standard (as defined in IEEE 802.21-2008) does not provide a technique for performing single radio handover, even with sophisticated media independent handover design.

As discussed above, existing single radio handover techniques may suffer from extended handover delay and increased handover failure rates when compared to multiple radio handover techniques. However, single radio handover performance may be improved by performing pre-handover signaling with the target network via the source network.

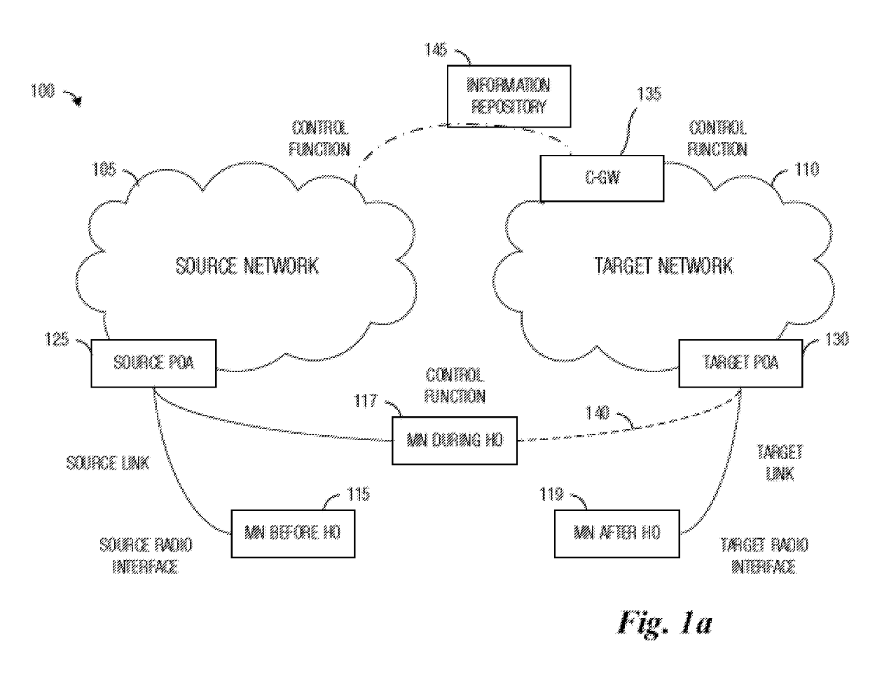

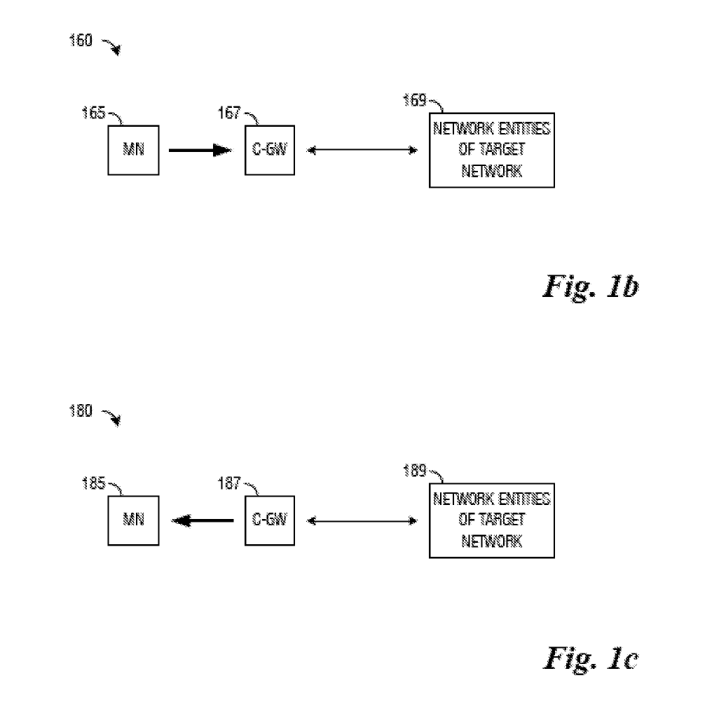

FIG. 1a illustrates a communications system 100. Communications system 100 includes a source network 105, a target network 110, and a mobile node (MN). While it is understood that communications systems may employ multiple networks capable of communicating with a number of MNs, only two networks and one MN are illustrated for simplicity.

The MN is illustrated in FIG. 1a in multiple states: a first state corresponds to the MN before handover (MN before HO) 115, which may include pre-handover signaling; a second state corresponds to the MN during handover (MN during HO) 117, which may include an actual execution of the handover; and a third state corresponds to the MN after handover (MN after HO) 119, which may include attachment to the target network.

Source network 105 may include a source point of attachment (source POA) 125, which may be a device to which the MN is attached to source network 105. As an example, if source network 105 is a 3GPP LTE compliant network, then source POA 125 may be an enhanced NodeB (eNB) or a relay node (RN), while if source network 105 is a WLAN compliant network, then source POA 125 may be an access point (AP), source network 105 is a WiMAX compliant network, then source POA 125 may be a base station, and so on. Similarly, target network 110 may include a target POA 130, which may be a device to which the MN wishes to handover to. The MN may or may not know the identity of its target POA 130.

Communications system 100 also includes a control gateway (C-GW) 135, which may also be referred to as a single radio handover signaling gateway (SRHO-GW), which may be located in a control plane of communications system 100. C-GW 135 may bridge control plane signaling between the MN and target network 110 by serving as a proxy between the MN and a target POA. To the MN, C-GW 135 may act like a virtual POA to target network 110, whereas to the target POA, C-GW 135 acts like a virtual MN.

Control frames from the MN may be tunneled via source network 105 to target network 110 may be received at C-GW 135, which processes the control frames. Before replying to the control frames, C-GW 135 may communicate with appropriate network entities in target network 110 to enable a conduction of functions requested in the control frames, such as pre-registration of the MN, proactive authentication of the MN, target link setup, and so forth. Communications between C-GW 135 and network entities in target network 110 may utilize existing messages defined in target network 110.

C-GW 135 is typically located in target network 110, such as in a gateway to target network 110. Since C-GW 135 normally resides in a gateway to target network 110, modifications to source network 105 is usually unnecessary. According to an example embodiment, a convenient location for C-GW 135 may be in a gateway router of target network 110. However, C-GW 135 may be located at other locations of target network 110. Furthermore, C-GW 135 may be disjoint from target network 110.

FIG. 1b illustrates a communications flow from a MN to network entities in a target network. As shown in FIG. 1b, a MN 165 transmits control frames to a C-GW 167 located in a gateway of the target network. C-GW 167 processes the control frames and communicates with network entities 169 of the target network.

FIG. 1c illustrates a communications flow from network entities in a target network to a MN. As shown in FIG. 1c, network entities 189 in the target network responds to communications from C-GW 187, which processes the responses from network entities 189 in the target network and communicates to MN 185 using control frames.

Referencing back to FIG. 1a, according to an example embodiment, C-GW 135 may use Internet Protocol (IP) to transport signaling messages, which helps to increase flexibility of C-GW 135 since IP is independent of individual network link layer protocols used in the different access interfaces.

As shown in FIG. 1a, prior to the execution of the handover, MN before HO 115 may use its interface (source radio interface) with source network 105 to attach to source POA 125 through a source link. The source link between MN before HO 115 and source network 105 may be established by a source radio of the MN that is connected to source POA 125, and can exchange data and/or signals. However, a link between the MN and target network 110 is not specified.

After handover, MN after HO 119 may use its interface (target radio interface) with target network 110 to attach to target POA 130 through a target link. The target link between MN after HO 119 and target network 110 may be established by a target radio of the MN that is connected to target POA 130, and can exchange data and/or signals. However, a link between the MN and source network 105 is not specified.

During handover, the source radio of the MN remains connected to source POA 125 and source network 105, maintaining the source link. The source link can exchange data and/or signals. A control function in the MN and a control function in source network 105 may use the source link to transport control plane messages.

During handover, a virtual target link (shown as dashed line 140) between the MN and target network 110 is maintained. Communications over the virtual target link may occur using one or more of the techniques presented herein. The control function in source network 105 and a control function in target network 110 may use the virtual target link to transport control plane messages.

During handover, the MN may communicate with target network 110 by exchanging signaling messages with target network 110 (as well as candidate target networks) via its source radio and a suitable communications mechanism between source network 105 and target network 110.

An information repository 145 may contain network information needed to make a handover decision, such as availability of candidate target networks, and so forth. Information repository 145 may reside in source network 105 or target network 110. Alternatively, information repository 145 may reside partly in source network 105 and target network 110. According to an example embodiment, a media independent information server (IS) may be used for information expressed in media independent format. Information repository 145 may also be implemented in such a network information repository as part of the Access Network Discovery and Selection Function (ANDSF) defined in the 3GPP LTE standards.

Furthermore, source network 105 and target network 110 may communicate with each other. For example, shortly after handover occurs, packets delivered to source network 105 and intended for the MN may be forwarded or tunneled to target network 110 for delivery to the MN.

According to an example embodiment, C-GW 135 bridges control plane signaling between the MN and target network 110 by way of source network 105. To the MN, C-GW 135 may act like a virtual POA to target network 110. C-GW 135 may enable functions such as pre-registration and allows for the proactive authentication of the MN. C-GW 135 may be resident of or co-located with a gateway to target network 110 and its single radio handover functionality may be implemented using a media independent point of service (POS). The functions of C-GW 135 may be located in a gateway router, for example.

As an example, in a WiMAX network, the functions of C-GW 135 may make use of signal forwarding functions (SFF). The functions of C-GW 135 may be shared by an access service network gateway (ASN-GW) which may operate basically as a gateway router and a SFF which may serve as a proxy. While in a WLAN AN, the functions of C-GW 135 may be shared by a WiFi Interworking Function (WIF) which may provide interoperability with a WiMAX CSN, an access router (AN) which may operate basically as a gateway router, and a WiFi SFF which may serve as a proxy. While in a 3GPP LTE network, the functions of C-GW 135 may be shared with a packet date network gateway (PDN-GW) which may operate basically as a gateway router and a mobility management entity (MME) which may serve as a proxy. In the 3GPP LTE network connected to an untrusted network, C-GW 135 functionality may also be shared with an ePDG which may allow access to untrused networks.

According to an example embodiment, control signaling between the MN and C-GW 135 is provided in a media independent manner. Media independent signaling may take advantage of media independent messages, such as those described herein. If a message not defined is used, encapsulation of the message with a media independent control frame header may be used.

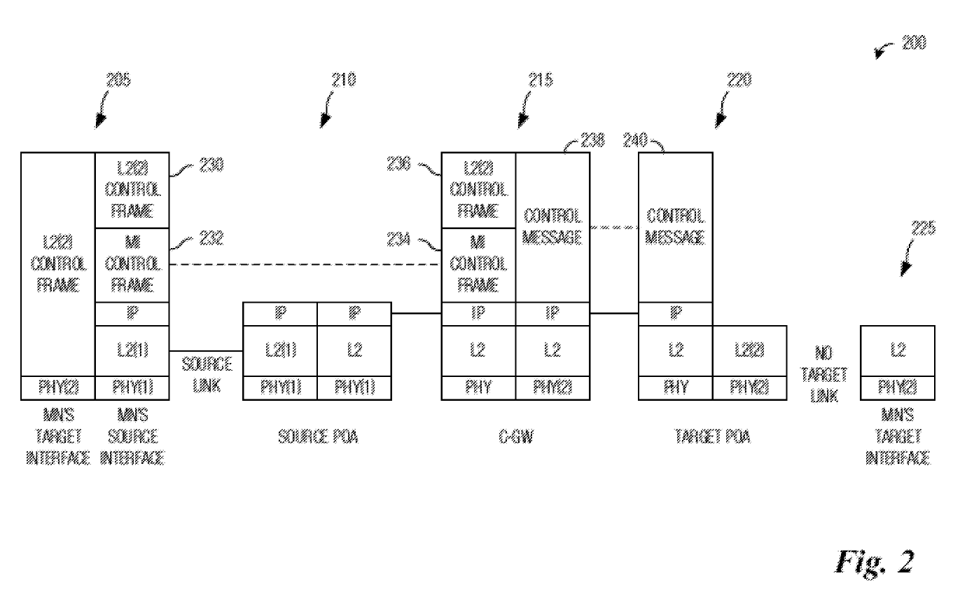

FIG. 2 illustrates a communications protocol layer view 200 of communications system 100. As shown in FIG. 2, different communications protocol layers involved in a single radio handover highlighted. A first protocol stack 205 illustrates protocol layers at a MN's target interface and source interface, a second protocol stack 210 illustrates protocol layers at a source network's source POA, a third protocol stack 215 illustrates protocol layers at a C-GW, a fourth protocol stack 220 illustrates protocol layers at a target network's target POA, and a fifth protocol stack 225 illustrates protocol layers at the MN's target interface that deals with the target network's target POA.

Communications protocol layer view 200 highlights the transport of a target network Layer 2 (L2) control frame between the MN and the target POA, but there no target link between the MN and the target POA. An L2 control frame 230 of the target radio of the MN may be encapsulated into a media independent (MI) control frame 232 and is transported over a source link to the MN's source POA. The source POA transports MI control frame 232 (shown as MI control frame 234) to the C-GW, where it is de-encapsulated as L2 control frame 236. The C-GW transports L2 control frame 236 encapsulated in a control message 238 (shown as control message 240) to the target network's target POA, again, using IP. A similar path may be taken by response messages from the target POA.

In order for the C-GW to act like a POA, the implementation of the C-GW may depend on the capabilities of the target network. Furthermore, the C-GW may need to actually communicate with the target POA so that may send reply messages to the MN on behalf of the target POA. Within the target network, the C-GW and the target POA may exchange messages according to the target network, as shown in FIG. 2, for example.

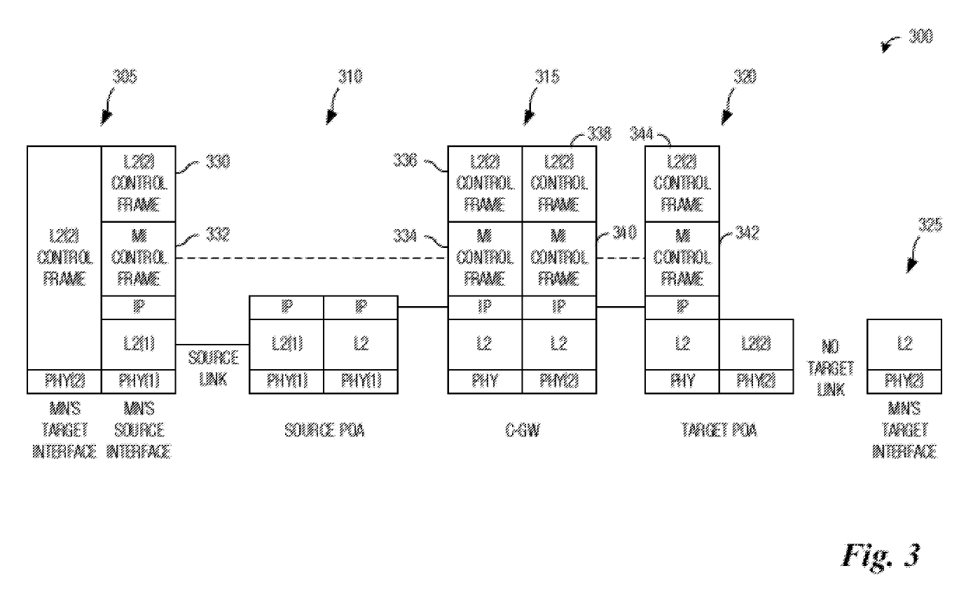

FIG. 3 illustrates a communications protocol layer view 300 of communications system 100, wherein a MI protocol is implemented at the target network. As shown in FIG. 3, different communications protocol layers involved in a single radio handover highlighted. A first protocol stack 305 illustrates protocol layers at a MN's target interface and source interface, a second protocol stack 310 illustrates protocol layers at a source network's source POA, a third protocol stack 315 illustrates protocol layers at a C-GW, a fourth protocol stack 320 illustrates protocol layers at a target network's target POA, and a fifth protocol stack 325 illustrates protocol layers at the MN's target interface that deals with the target network's target POA.

Communications protocol layer view 300 highlights the transport of a target network Layer 2 (L2) control frame between the MN and the target POA, but there no target link between the MN and the target POA. An L2 control frame 330 of the target radio of the MN may be encapsulated into a MI control frame 332 and is transported over a source link to the MN's source POA. The source POA transports MI control frame 332 (shown as MI control frame 334) to the C-GW, where it is de-encapsulated as L2 control frame 336. The C-GW transports L2 control frame 336 (shown as L2 control frame 338) encapsulated in a MI control frame 340 (shown as MI control frame 342) to the target network's target POA, again, using IP. The target POA de-encapsulates MI control frame 342 as L2 control frame 344. A similar path may be taken by response messages from the target POA.

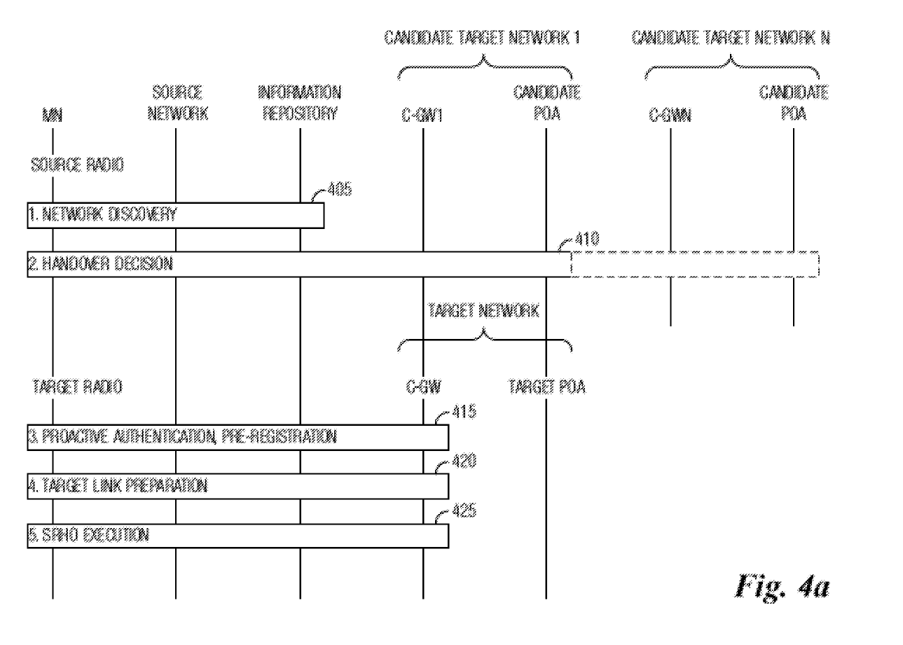

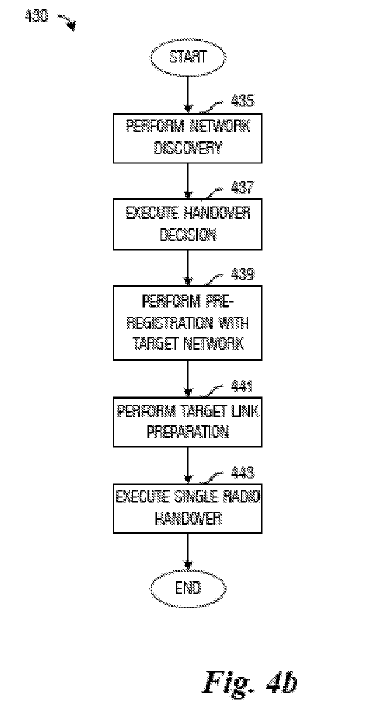

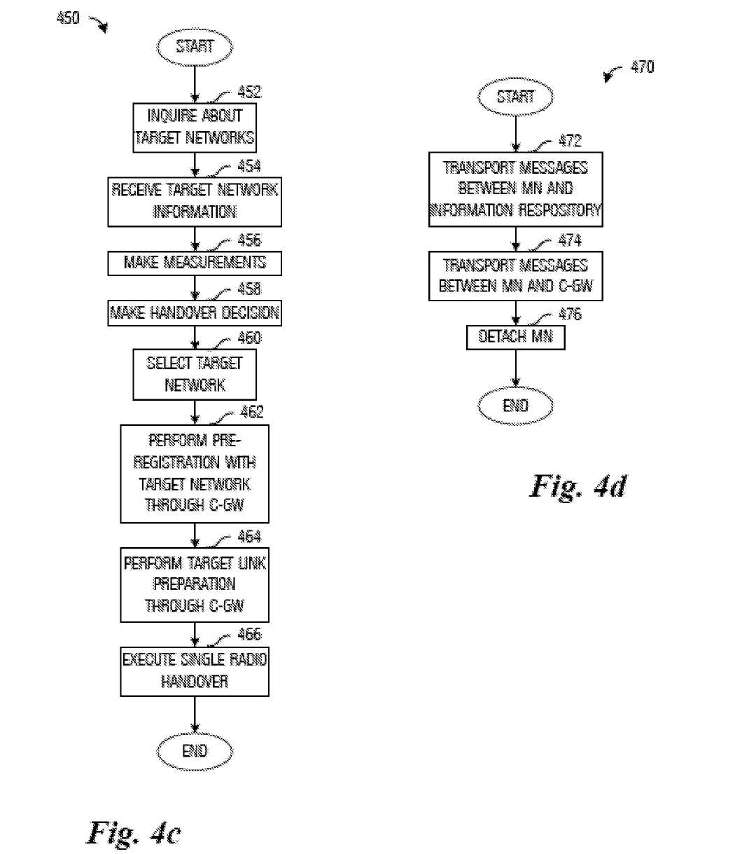

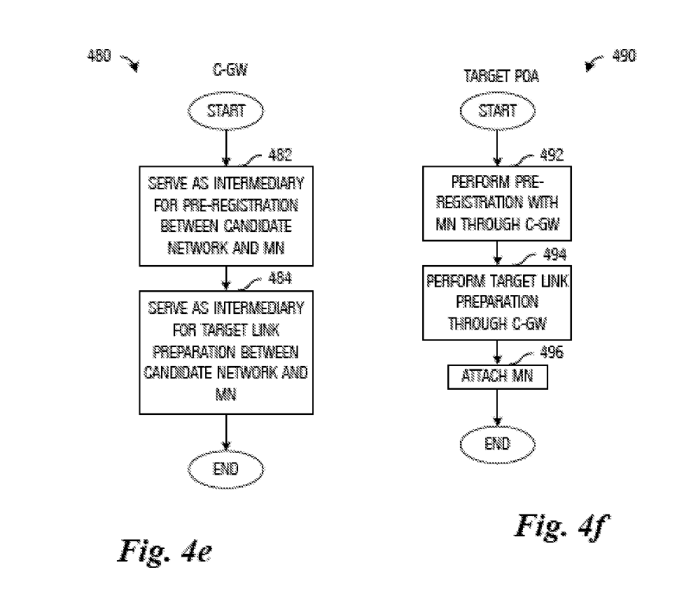

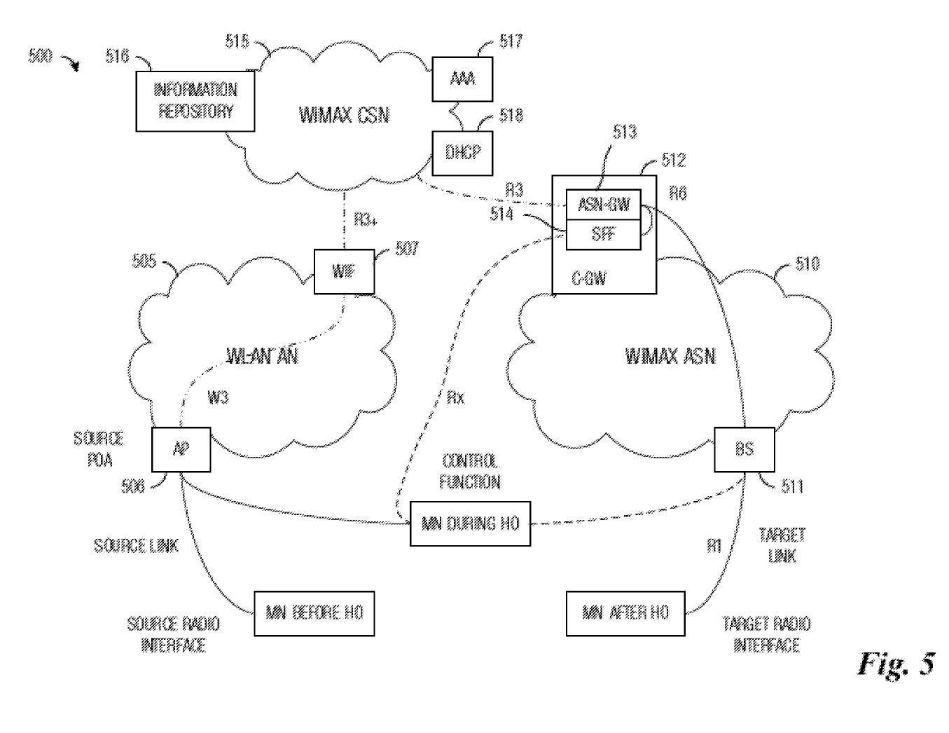

FIG. 4a illustrates a diagram 400 of interaction between various entities in a communications system that is performing a single radio handover. Diagram 400 illustrates interaction between a MN that is attached to a source network, but desirous to participate in a single radio handover (due to mobility, for example) with a target network out of N candidate target networks. The single radio handover may be supported by an information repository.

The single radio handover may begin with network discover 405. Network discovery may involve the MN, the source network, and the information repository. In network discovery, the MN may inquire from the information repository which candidate target networks are suitable for a handover. The information repository may provide the MN with up to N candidate target networks, where N may range from zero and up. The information repository may also provide to the MN information about the handover policy. The handover information may include whether candidate networks and the MN supports single radio handovers. The handover information may also include information about the presence of C-GWs in the candidate networks. Network discovery also allows the MN to acquire corresponding system information blocks about candidate POAs to perform radio measurements. Communications between the MN and the information repository may be through the source network.

The single radio handover may continue with a handover decision 410. A handover decision may involve the following: 1) the handover may be triggered by a need; 2) A target network may be selected from the candidate target networks and a C-GW may be discovered; and 3) A determination may be made regarding benefits of performing the handover. The decision may be made by the MN or the target network. As an example of such a decision may be based on consideration of selection parameters such as signal strength, operating cost, operator policy, signal strength, interference level, target network load, historical target network performance, target network performance guarantees, and so forth. In order to determine whether or not the target network has better signal strength, the MN may use its target interface to listed to broadcast channels from the target POA of the target network.

Based on communications with the target POAs of the N candidate target networks, the MN may select a candidate target network as the target network. Alternatively, one or more of the N candidate target networks may respond to the MN and agree to be the target network for the MN. If there are more than one target network, the MN may select one based on a target network selection factor, which may include signal strength, interference level, target network load, historical target network performance, target network performance guarantees, and so forth.

For discussion purposes, let candidate target network 1 be selected as the target network. Single radio handover may continue with a pre-registration of the MN 415. Pre-registration may include proactive authentication and/or establishment of context (such as user identity, security, resource information, and so on) at the target network. With help of the C-GW, the MN can perform network entry procedures towards the target network while retaining its source link with the source network. Optionally, the pre-registration process may occur before the network selection process, as in the case of WiMAX networks.

Target link preparation 420 may involve the MN and the target network preparing for the establishment of the target link. The target link preparation process may help to ensure that the target network has sufficient resources to accommodate the target link and may include performing resource reservation and/or admission control The target link preparation process also helps to confirm that signal conditions are sufficiently favorable to establish the target link.

With the target link prepared, the single radio handover may be executed 425. As described previously, the execution of the single radio handover may involve the termination of the source link and the establishment of the target link. Establishment of the target link may involve the activation of a target radio and establishment of the target link. Since the MN has been authenticated and pre-registered, as well as the preparation of the target link, the execution of the single radio handover may occur with short delay and with high probability of success. The association of a network layer address to a link layer address will change from a source link layer address to a target link layer address, and future incoming packets may be routed to the target radio.

While it is desirable to have C-GW functionality at target networks, existing access networks may not have full C-GW functionality. Therefore, modifications to existing access networks may be necessary. In order to reduce the modifications to the existing access networks, as much existing functionality is reused as possible to implement C-GW functionality.

FIG. 4b illustrates a flow diagram of operations 430 in a single radio handover. Operations 430 may be indicative of operations occurring in entities of a communications system as a MN operating in the communications system performs a single radio handover from a source network to a target network.

Operations 430 may begin with the MN performing network discovery (block 435). As discussed previously, network discovery may include the MN inquiring about candidate target networks to which it may perform a single radio handover. The MN may inquire regarding the candidate target networks at an information repository. Network discovery may also include the MN making signal strength measurements of the candidate target networks.

The MN may execute (e.g., make) a handover decision (block 437). The handover decision may involve determining whether or not a handover is needed, selecting a target network, discovering a C-GW associated with the target network, considering a benefit(s) in performing the handover, and so on.

For discussion purposes, consider that the MN decided to proceed with the single radio handover. The MN may perform pre-registration with the target network (block 439). Pre-registration may include proactive authentication and/or establishment of context (such as user identity, security, resource information, and so on) at the target network. Since a single radio handover is being used, the MN may not be able to directly communicate with the target network. Instead, the pre-registration may need to occur through an intermediary (or bridge), the C-GW. The MN may communicate with the C-GW through its source network and the C-GW communicates with the target network and a target POA on behalf of the MN. Similarly, the C-GW may allow the target network and the target POA to communicate with the MN without having a direct link to the MN.

The MN may perform target link preparation (block 441). Target link preparation may involve the MN and the target network preparing for the establishment of the target link. Again, since the MN cannot directly communicate with the target POA, the C-GW may serve as intermediary (or bridge).

With the pre-registration performed and the target link prepared, the MN, a source POA, the source network, the target network, and the target POA may execute the single radio handover (block 443).

FIG. 4c illustrates a flow diagram of MN operations 450 in a single radio handover. MN operations 450 may be indicative of operations occurring in a MN as the MN participates in a single radio handover from a source network to a target network.

MN operations 450 may begin with the MN inquiring about target networks (block 452). According to an example embodiment, the MN may inquire at an information repository about target networks that are near the MN. The MN may receive from the information repository information for a number of candidate target networks (block 454). The MN may make measurements, such as signal strength measurements, for the candidate target networks. Results of the measurements may be used by the MN to select the target network from the candidate target networks.

The MN may make a decision about proceeding with the single radio handover (block 458). The decision may be based on factors such as need, costs, and so forth. The MN may also select the target network (block 460).

With the target network selected, the MN may perform pre-registration in the target network (block 462) and target link preparation (block 464). However, since the MN is performing a single radio handoff, it may not be possible for the MN to directly communicate with a target POA of the target network. Therefore, the MN may communicate with the target POA of the target network through a C-GW. The C-GW may serve as an intermediary (or bridge) between the MN and the target POA of the target network. The C-GW may perform packet encapsulation, de-encapsulation, translation, and so on, for packets shared between the MN and the target POA of the target network.

After pre-registration and target link preparation, the MN may execute the single radio handover (block 466). Executing the single radio handover may include termination of a source link between the MN and a source POA of the source network, and establishment of a target link between the MN and the target POA of the target network.

FIG. 4d illustrates a flow diagram of source POA operations 470 in a single radio handover. Source POA operations 470 may be indicative of operations occurring in a source POA as a MN connected to the source POA participates in a single radio handover from a source network to a target network.

Source POA operations 470 may begin with the source POA transporting messages between the MN and an information repository as the MN performs network discovery (block 472).

For discussion purposes, consider a scenario wherein the MN has decided to proceed with the single radio handover. In order to proceed with the single radio handover, the MN may need to pre-register with the target network as well as perform target link preparation with the target network through a C-GW. The source POA may transport messages between the MN and the C-GW (block 474).

After the MN completes pre-registration and target link preparation, the MN may execute the single radio handover. Part of the single radio handover involves the termination of a source link between the MN and the source POA. Therefore, the source POA may detach the MN from the source network (block 476).

FIG. 4e illustrates a flow diagram of C-GW operations 480 in a single radio handover. C-GW operations 480 may be indicative of operations occurring in a C-GW as a MN desiring to perform a single radio handover to from a source network to a target network, wherein the C-GW is coupled to the target network.

C-GW operations 480 may begin with the C-GW serving as an intermediary (or bridge) for pre-registration of the MN in the target network (block 482). The C-GW may also serve as the intermediary (or bridge) for target link preparation between the MN and a target POA of the target network (block 484).

In general, the C-GW may intercept transmissions (such as control frames) from the MN targeted to network entities in the target network. The C-GW may then process the transmissions and generate transmissions to the network entities in the target network, performing transmission translation, protocol translation, address translation, and so forth, as needed. Similarly, C-GW may intercept responses from the network entities in the target network and generate transmissions to the MN. As an example, the C-GW may intercept pre-registration, proactive authentication, target link setup, and so on, messages from the MN and responses therefore from the network entities.

As an example, serving as the intermediary (or bridge) may involve encapsulating and de-encapsulating transmissions (packets) transmitted by the MN and/or entities in the target network to allow transmissions using incompatible protocols to travel through the various networks. Additionally, payload of the transmissions may be modified by the C-GW. Furthermore, as intermediary (or bridge), the C-GW may assist in performing the pre-registration and/or the target link preparation.

FIG. 4f illustrates a flow diagram of target POA operations 490 in a single radio handover. Target POA operations 490 may be indicative of operations occurring in a target POA as a MN connected to a source POA participates in a single radio handover from a source network to a target network.

Target POA operations 490 may begin with the target POA performing pre-registration with the MN (block 492). The target POA may also perform target link preparation with the MN (block 494). Since there is no direct link between the target POA and the MN, the pre-registration and the target link preparation may need to be performed through an intermediary (or bridge), e.g., a C-GW. The C-GW may perform protocol translation of transmissions (packets) for the target POA and the MN.

Furthermore, as part of the single radio handover, the MN may attach to the target POA after the MN as detached from the source POA (block 496).

FIG. 5 illustrates a communications system 500, wherein a single radio handover between a WLAN AN and a WiMAX network occurs. Communications system 500 includes a WLAN AN 505, a WiMAX access service network (ASN) 510, and a WiMAX connectivity service network (CSN) 515. WLAN AN 505 includes an AP 506 that serves as a POA, such as a source POA, for a MN. WLAN AN 505 also includes a WiFi Interworking Function (WIF) 507, which may provide interoperability with WiMAX CSN 515.

WiMAX ASN 510 includes a base station (BS) 511 that serves as a POA, such as a target POA, for the MN. WiMAX ASN 510 also includes a C-GW 512. According to an example embodiment, the functionality of a C-GW may be implemented in C-GW 512 with an ASN-GW 513 and a WiMAX Signal Forwarding Function (SFF) 514. As shown in FIG. 5, ASN-GW 513 and SFF 514 may be co-located. In an event that ASN-GW 513 and SFF 514 are not co-located, ASN-GW 513 and SFF 514 may communicate over a communications interface, such as an R6 interface.

WiMAX CSN 515 includes an information repository 516, which may be implemented in a media independent information server (MIIS) as defined herein or as another type of information repository, such as an Access Network Discovery and Selection Function (ANDSF), defined elsewhere. WiMAX CSN 515 also includes an authentication, authorization, and accounting server (AAA) 517 and a dynamic host configuration protocol (DHCP) server 518.

According to an example embodiment, C-GW 512 implements the C-GW functionality with the combined functions of ASN-GW 513 and SFF 514, which are both defined in a WiMAX network. To the MN, C-GW 512 acts like a virtual target POA in the target network. To the target POA, C-GW 512 acts like a virtual target radio interface of the MN. The functionality of C-GW 512 as described previously.

A W3 interface between AP 506 and WIF 507, an RX interface between the MN and the SFF 514, an R3 interface between WiMAX CSN 515 and WiMAX ASN 510, an R3+ interface between WIF 507 and AAA 517 and also DHCP 518, and an R6 interface between SFF 514 and ASN-GW 513 are as defined in the WiMAX standards.

Referencing the terminology presented in FIG. 4, a WLAN to WiMAX single radio handover may proceed as follows:

Network discovery: The MN queries information repository 516, which may be implemented as a MIIS. Alternatively, other implementations of information repository, such as an ANDSF, are possible. Discovery of the information repository 516 may be made through DHCP according to procedures as defined in IETF rfc6153. The queries from the MN and responses from information repository 516 may use IP connectivity of the source link.

Information repository 516 may provide the MN with information about available networks and handover policy. Information repository 516 may also inform the MN whether WiMAX ASNs of the available networks support single radio handover, as well as system information blocks of candidate POAs to allow the MN to perform radio measurements.

Pre-registration includes proactive authentication and establishing contexts (such as, user identity, security, resource information, and so on) at the target network (WiMAX ASN 510). With help from C-GW 512, the MN can perform network entry procedures towards the target network (WiMAX ASN 510) while maintaining its connection with the source network (WLAN AN 505).

The MN and the target network (WiMAX ASN 510) perform proactive authentication via the source network (WLAN AN 505). The exchange of handshake messages for authentication is as follows:

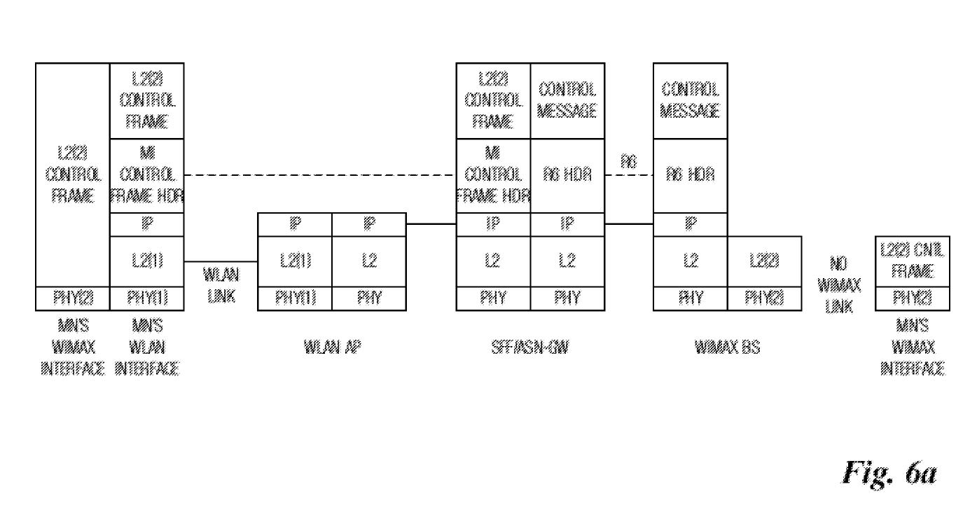

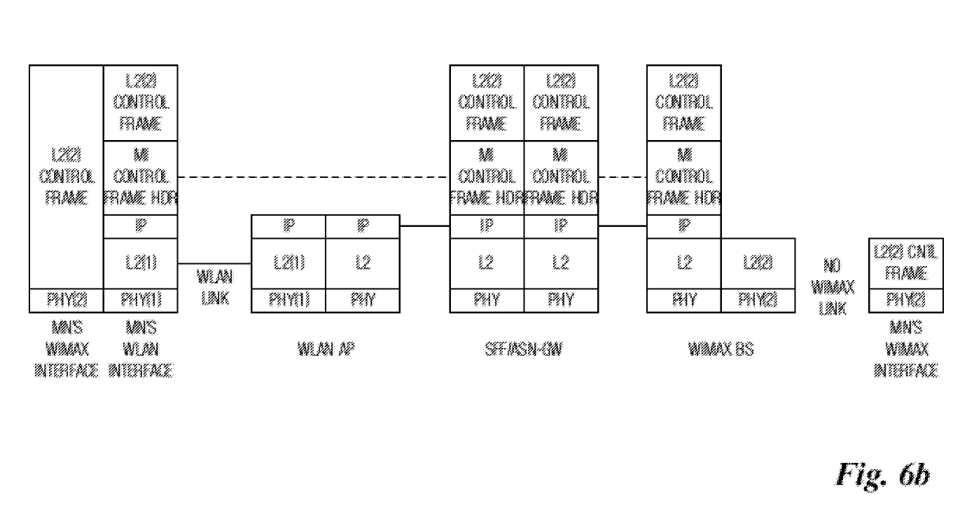

The handshake messages for authentication are exchanged between the MN and ASN-GW 513, which may be serving as the authenticator. The handshake messages are L2 control frame messages in the target network (WiMAX ASN 510), which could have been exchanged via the target link if the target link were available. When the target link is not available, the transport of the L2 control frame between the MN and ASN-GW 513 is through the source network (WLAN AN 505) using media independent control frames, whereas the R6 interface or the media independent control frame may be used between ASG-GW 513 and BS 511 as shown respectively in FIG. 6a and FIG. 6b.

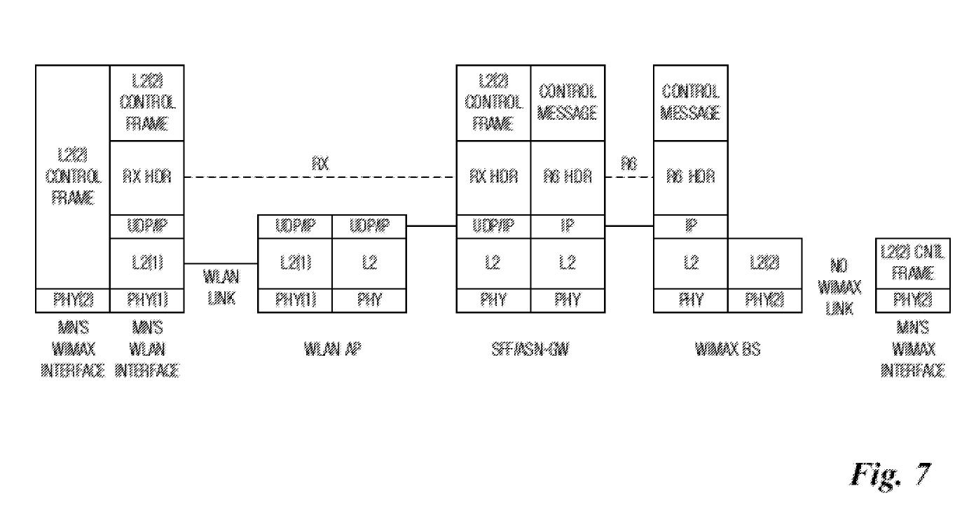

Alternatively, the Rx interface may be used between the MN and SFF 514, and the R6 interface may be used between ASN-GW 513 and BS 511 in WiMAX ASN 510 as shown in FIG. 7.

As shown in FIGS. 6a, 6b, and 7, a WiFi link is illustrated as the source link and a missing WiMAX link is illustrated as the target link. A WiMAX radio L2 control frame may be transported using L2 transport to communicate with BS 511 in a multiple radio handover scenario. However, in a single radio handover, the L2 control frame may be tunnel through the source link using a MI control frame (as shown in FIGS. 6a and 6b) or an Rx interface (as shown in FIG. 7) to SFF 514, co-located with ASN-GW 513. The combination of ASN-GW 513 and SFF 514 (i.e., C-GW 512) behaves as a virtual target POA.

C-GW 512 (ASN-GW 513 and SFF 514) processes the L2 control frame and may consult AAA 517 in WiMAX CSN 515 through an R3 interface. ASN-GW 513 may maintain a higher layer registration context including security keys and data path information to maintain the IP session. Registration with C-GW 512 (ASN-GW 513 and SFF 514) results in pre-registration for WiMAX ASN 510, which may have multiple POAs. When the MN attaches to a different target POA (e.g., BS), if C-GW 512 (ASN-GW 513 and SFF 514) already has the registration context, the registration context may be reused.

C-GW 512 (ASN-GW 513 and SFF 514) also constructs control messages to communicate with BS 511. As it relates to exchanging these control messages, C-GW 512 (ASN-GW 513 and SFF 514) behaves like a virtual WiMAX BS located in WiMAX ASN 510 that is communicating with the MN. These control messages are equivalent to control messages used in a handover between BSs within a single network. Therefore, the control messages may reuse the control messages exchanged between a source POA and a target POA within the same network to prepare for the handover of a MN within the same network.

Messages sent between C-GW 512 and the MN may be tunneled to the MN using the WiFi network. To BS 511, C-GW 512 acts like a virtual WiMAX radio interface.

The MN may pre-register with WiMAX ASN 510 using the same interface and transport mechanism as shown for proactive authentication.

An example handover decision process is as follows:
WiMAX link preparation: Before a L3 handover occurs, the target link may perform preparation processes at L2, such as signal strength measurement, power level adjustment, and so forth.
A target POA (BS 811) is selected. The MN may use the target interface to check the broadcast messages from the target POA to confirm that there is sufficient signal strength, for example.
WiMAX ASN 510 may check with the target POA and ASN-GW 513 to reserve radio resources needed for the MN to attach to WiMAX ASN 510. The resources needed for the MN to operate in either active or idle mode may be assigned depending on whether the source radio was in an active or an idle mode.

Single radio handover execution. In single radio handover, the WiFi link is disconnected and the WiMAX radio is activated. The WiMAX link (the target link) is established to complete the L3 handover. The association of the network layer address to the link layer address may change from the WiFi link layer address to the WiMAX link layer address, and future incoming packets are then routed to the WiMAX radio.

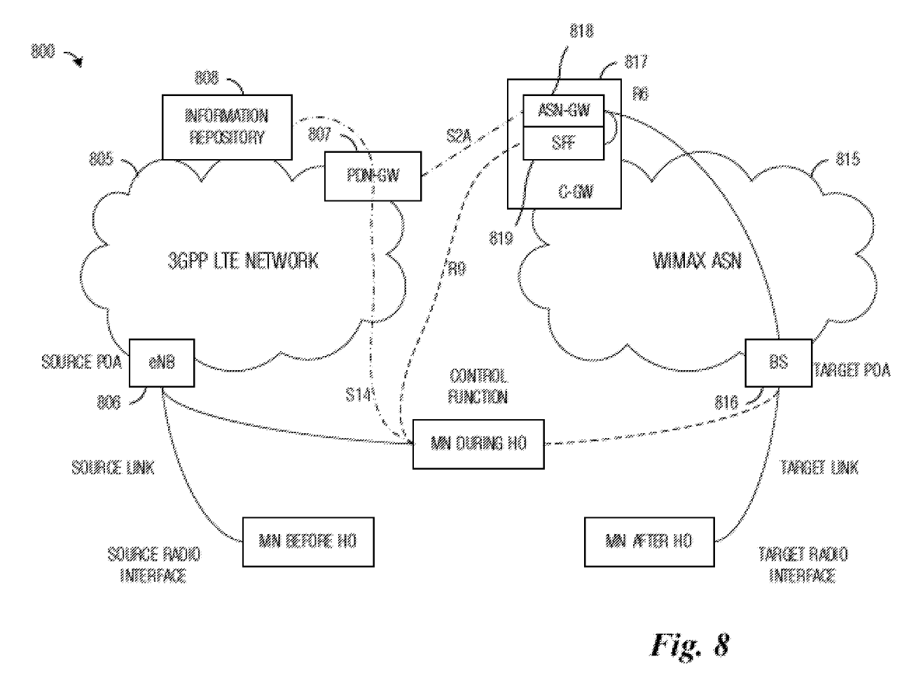

FIG. 8 illustrates a communications system 800. Communications system 800 includes a 3GPP LTE network 805 and a WiMAX ASN 815. 3GPP LTE network 805 includes an eNB 806 that serves as a POA, such as a source POA, for a MN. 3GPP LTE network 805 also includes a packet data network gateway (PDN-GW) 807, which may provide interoperability with WiMAX ASN 815, and an information repository 808, which may be implemented as an MIIS, an ANDSF, or so on.

WiMAX ASN 815 includes BS 816 that serves as a POA, such as a target POA, for the MN. WiMAX ASN 815 also includes a C-GW 817. According to an example embodiment, the functionality of a C-GW may be implemented in C-GW 817 with an ASN-GW 818 and a SFF 819. As shown in FIG. 8, ASN-GW 818 and SFF 819 may be co-located. In an event that ASN-GW 818 and SFF 819 are not co-located, ASN-GW 818 and SFF 819 may communicate over a communications interface, such as an R6 interface.

To the MN, C-GW 817 acts like a virtual target POA in the target network. To the target POA, C-GW 817 acts like a virtual target radio interface of the MN. The functionality of C-GW 817 as described previously.

An S2a interface between PDN-GW 807 and ASN-GW 818, and a S14 interface between the MN and information repository 808 is as defined in the 3GPP LTE standards, and an R6 interface between SFF 819 and ASN-GW 818, and an R9 interface between the MN and SFF 819 is as defined in WiMAX Forum.

Referencing the terminology presented in FIG. 4, a 3GPP LTE to WiMAX single radio handover may proceed as follows:

Network discovery: The MN queries information repository 808, which may be implemented as a MIIS. Alternatively, other implementations of the information repository 808, such as an ANDSF, are possible. Discovery of information repository 808 may be through DHCP according to procedures defined in IETF rfc6153. The queries from the MN and responses from information repository 808 are carried in IP packets and may use IP connectivity of the source link. The message exchanged between the MN and information repository 808 may use a S14 interface as defined in the 3GPP LTE standards.

Information repository 808 provides the MN with information about available networks and handover policy. It will also inform the MN whether WiMAX ASNs of the available networks supports single radio handover, the presence of SFF 819, and system information blocks of candidate POAs to allow the MN to perform radio measurements.

Pre-registration includes proactive authentication and establishing context (such as, user identity, security, resource information, and so on) at the target network. With the help of C-GW 817, the MN may perform network entry procedures towards the target network while retaining its data connection with the source network.

The MN and the target network (WiMAX ASN 815) perform proactive authentication via the source network (3GPP LTE network 805). The exchange of handshake messages for authentication is as follows:

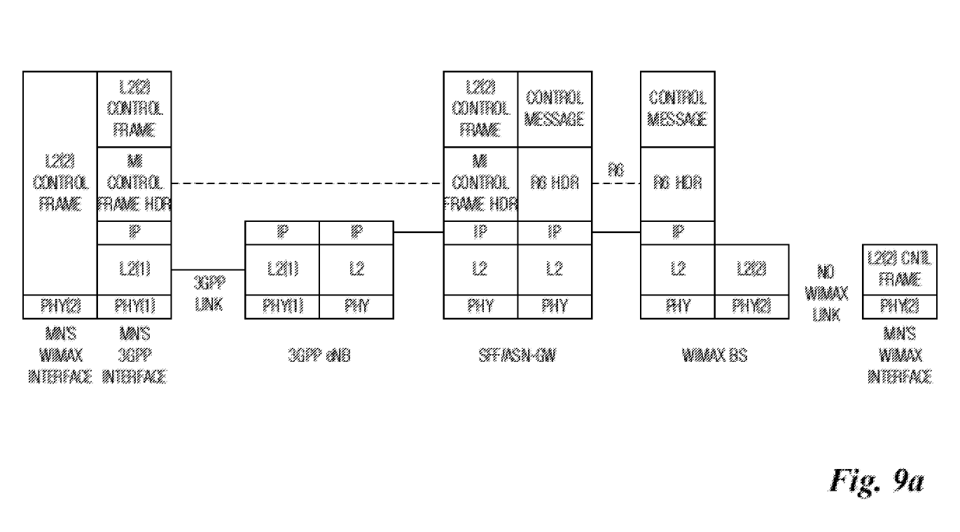

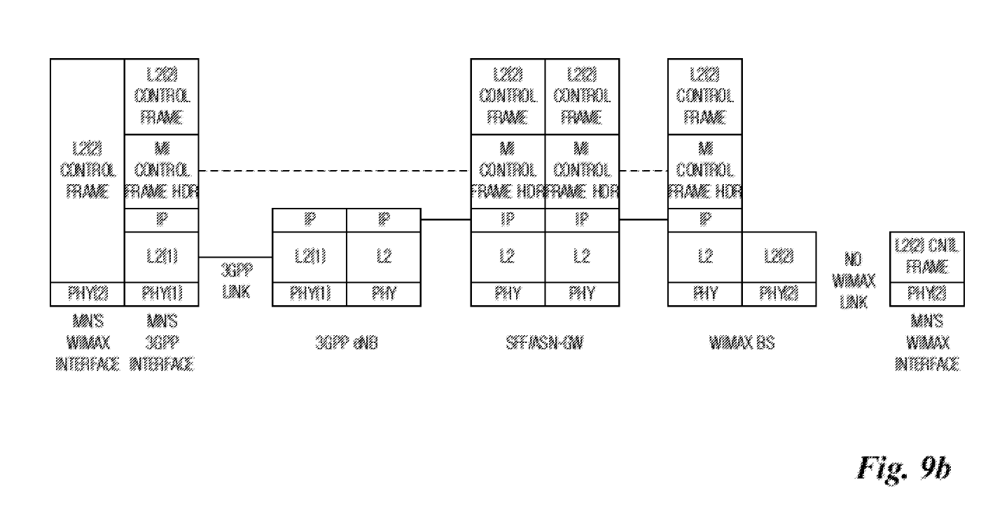

The handshake messages for authentication are exchanged between the MN and ASN-GW 818, which may be serving as the authenticator. These messages are L2 control frame messages in the target network (WiMAX ASN 815), which could have been exchanged via the target link if the target link were available. When the target link is not available, the transport of the L2 control frame between the MN and ASN-GW 818 is through the source network (3GPP LTE network 805) using media independent control frames, whereas the R6 interface or the media independent control frame may be used between ASG-GW 818 and the BS 816 as shown respectively in FIG. 9a and FIG. 9b.

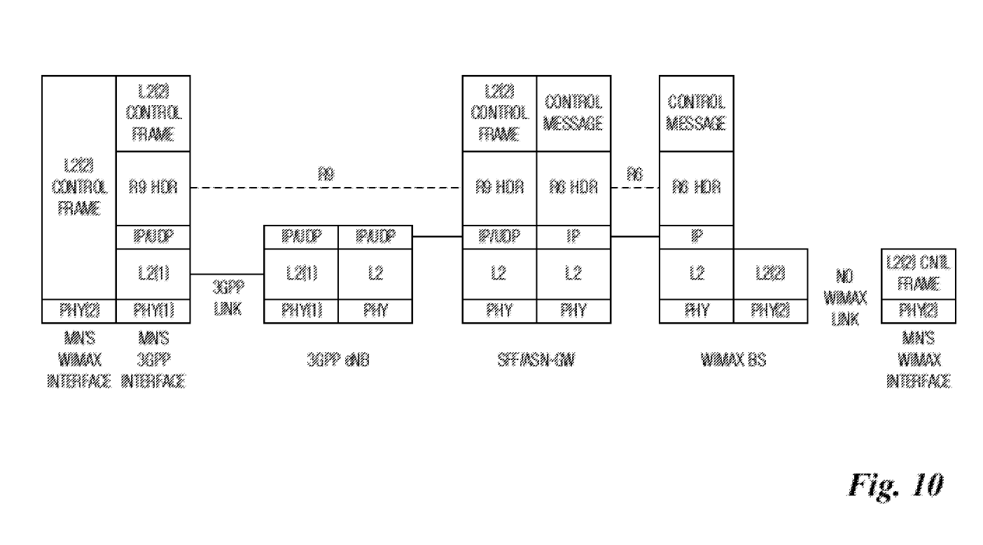

Alternatively, the R9 interface may be used between the MN and SFF 819, and the R6 interface may be used between ASN-GW 818 and BS 816 in WiMAX ASN 815 as shown in FIG. 10.

As shown in FIGS. 9a, 9b, and 10, a 3GPP LTE link is illustrated as the source link and a missing WiMAX link is illustrated as the target link. A WiMAX radio L2 control frame may be transported using L2 transport to communicate with BS 816 in a dual radio handover scenario. However, in a single radio handover, the L2 control frame may be tunneled through the source link using the MI control frame (as shown in FIGS. 9a and 9b) or the R9 interface (as shown in FIG. 10) to SFF 819 co-located with ASN-GW 818. The combination of ASN-GW 818 and SFF 819 (i.e., C-GW 817) behaves as a virtual target POA.

C-GW 817 (ASN-GW 818 and SFF 819) processes the L2 control frame and may consult an AAA in a WiMAX CSN through an R3 interface. ASN-GW 818 may maintain a higher layer registration context including security keys and data path information to maintain the IP session. Registration with C-GW 817 (ASN-GW 818 and SFF 819) results in pre-registration for WiMAX ASN 815, which may have multiple POAs. When the MN attaches to a different target POA (e.g., BS), if C-GW 817 (ASN-GW 818 and SFF 819) already has the registration context, the registration context may be reused.

C-GW 817 (ASN-GW 818 and SFF 819) also constructs control messages to communicate with BS 816. As it relates to exchanging these control messages, C-GW 817 (ASN-GW 818 and SFF 819) behaves like a virtual WiMAX BS located in WiMAX ASN 510 that is communicating with the MN. These control messages are equivalent to control messages used in a handover between BSs within a single network. Therefore, the control messages may reuse the control messages exchanged between a source POA and a target POA within the same network to prepare for the handover of a MN within the same network.

Messages sent between C-GW 817 and the MN may be tunneled to the MN using the 3GPP LTE network. To BS 816, C-GW 817 acts like a virtual WiMAX radio interface.

The MN may pre-register with WiMAX ASN 815 using the same interface and transport mechanism as shown for proactive authentication.

An example handover decision process is as follows:
WiMAX link preparation: Before a L3 handover occurs, the target link may perform preparation processes at L2, such as signal strength measurement, power level adjustment, and so forth.
A target POA (BS 816) is selected. The MN may use the target interface to check the broadcast messages from the target POA to confirm that there is sufficient signal strength, for example.
WiMAX ASN 815 may check with the target POA and ASN-GW 818 to reserve radio resources needed for the MN to attach to WiMAX ASN 815. The resources needed for the MN to operate in either active or idle mode may be assigned depending on whether the source radio was in an active or an idle mode.

Single radio handover execution. In single radio handover, the 3GPP LTE link is disconnected and the WiMAX radio is activated. The WiMAX link (the target link) is established to complete the L3 handover. The association of the network layer address to the link layer address may change from the 3GPP LTE link layer address to the WiMAX link layer address, and future incoming packets are then routed to the WiMAX radio.

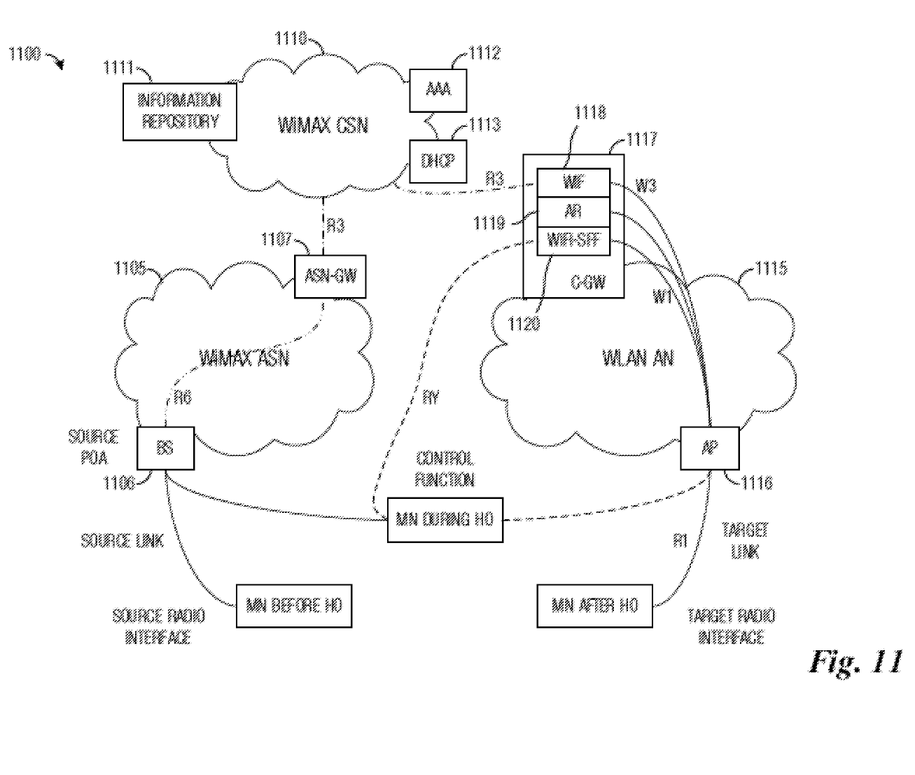

FIG. 11 illustrates a communications system 1100. Communications system 1100 includes a WiMAX ASN 1105, a WiMAX CSN 1110, and a WLAN AN 1115. Generally, a WLAN network is simple and does not possess many functions compared with a WiMAX network and a 3GPP LTE network. There may not be enough WLAN functions in the WLAN access network alone to perform the task of a C-GW. However, new WLAN functions are being defined in Hotspot 2.0. New WLAN functions are also defined in WiMAX to enable WLAN access to the WiMAX network.

WiMAX ASN 1105 includes a BS 1106 that serves as a POA, such as a source POA, for a MN. WiMAX ASN 1105 also includes an ASN-GW 1107, which may provide functionality to WiMAX CSN 1110.

WiMAX CSN 1110 includes an information repository 1111, which may be implemented as a MIIS as defined herein or as another type of information repository, such as an ANDSF, defined elsewhere. WiMAX CSN 1110 also includes an AAA 1112 and a DHCP 1113.

WLAN AN 1115 includes an AP 1116 that serves as a POA, such as a target POA, for the MN. WLAN AN 1115 also includes a C-GW 1117. According to an example embodiment, the functionality of a C-GW may be implemented in C-GW 1117 with a WIF 1118, an access router (AR) 1119, and a WiFi SFF 1120. As shown in FIG. 11, WIF 1118, AR 1119, and WiFi SFF 1120 may be co-located. In an event that they are not co-located, WIF 1118, AR 1119, and WiFi SFF 1120 may communicate over a communications interface.

According to an example embodiment, C-GW 1117 implements the C-GW functionality with the combined functions of WIF 1118, AR 1119, and WiFi SFF 1120. To the MN, C-GW 1117 acts like a virtual target POA in the target network. To the target POA, C-GW 1117 acts like a virtual target radio interface of the MN. The functionality of C-GW 1117 is as described previously.

A W1 interface between AP 1116 and WiFi SFF 1120, a is W3 interface between AP 1116 and WIF 1118, a Ry interface between the MN and WiFi SFF 1120, a R3 interface between WiMAX CSN 1110 and WiMAX ASN 1115, an R3+ interface between WIF 1118 and AAA 1112 and also DHCP 1113, and a R6 interface between WiFi SFF 1120 and ASN-GW 1107 are as defined in WiMAX standards.

Referencing the terminology presented in FIG. 4, a WiMAX to WLAN single radio handover may proceed as follows:

Network discovery: The MN queries information repository 1111, which may be implemented as a MIIS. Alternatively, other implementations of information repository, such as an ANDSF, are possible. Discovery of the information repository 1111 may be made through DHCP according to procedures as defined in IETF rfc6153. The queries from the MN and responses from information repository 1111 may use IP connectivity of the source link.

Information repository 1111 may provide the MN with information about available networks and handover policy. Information repository 1111 may also inform the MN whether WLAN ANs of the available networks support single radio handover, as well as frequency and channel information of candidate POAs to allow the MN to perform radio measurements.

Pre-registration includes proactive authentication and establishing contexts (such as, user identity, security, resource information, and so on) at the target network (WLAN AN 1115). With help from C-GW 1117, the MN can perform network entry procedures towards the target network (WLAN AN 1115) while maintaining its connection with the source network (WiMAX ASN 1105).

The MN and the target network (WLAN AN 1115) perform proactive authentication via the source network (WiMAX ASN 1105). The exchange of handshake messages for authentication is as follows:

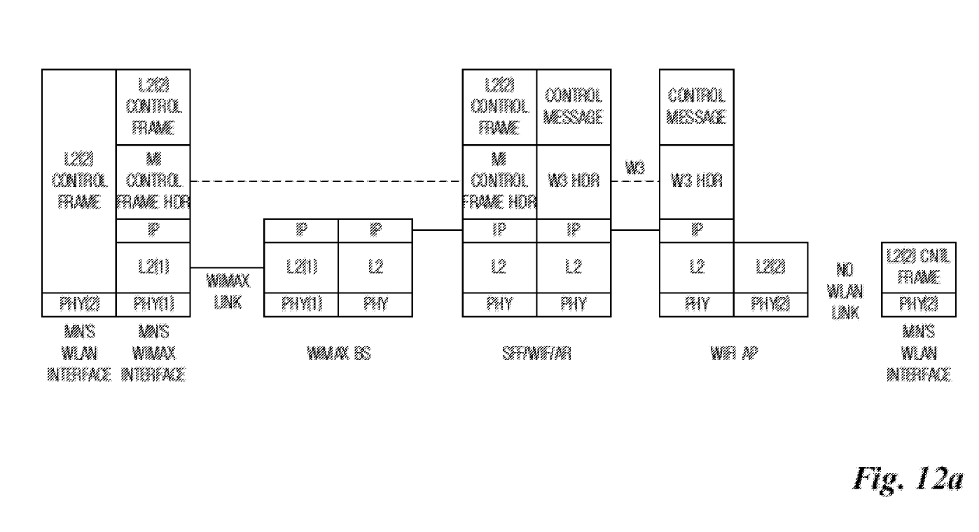

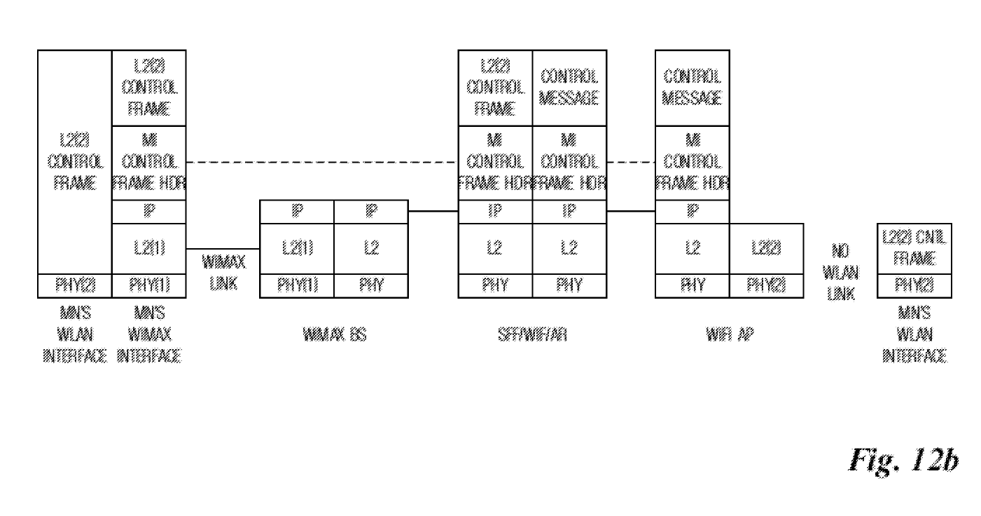

The handshake messages for authentication are exchanged between the MN and AR 1119, which may be serving as the authenticator. The handshake messages are L2 control frame messages in the target network (WLAN AN 1115), which could have been exchanged via the target link if the target link were available. When the target link is not available, the transport of the L2 control frame between the MN and AR 1119 is through the source network (WiMAX ASN 1105) using media independent control frames, whereas the W3 interface or the media independent control frame may be used between AR 1119 and AP 1116 as shown respectively in FIG. 12a and FIG. 12b.

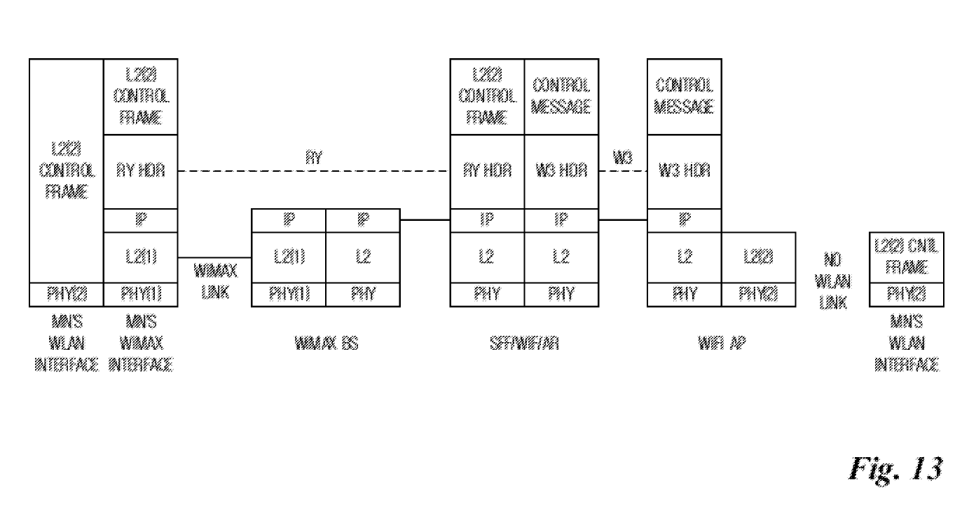

Alternatively, the Ry interface may be used between the MN and WiFi SFF 1120, and the W3 interface may be used between AR 1119 and AP 1116 in WLAN AN 1115 as shown in FIG. 13.

As shown in FIGS. 12a, 12b, and 13, a WiMAX link is illustrated as the source link and a missing WiFi link is illustrated as the target link. A WiFi radio L2 control frame may be transported using L2 transport to communicate with BS 1106 in a multiple radio handover scenario. However, in a single radio handover, the L2 control frame may be tunnel through the source link using a MI control frame (as shown in FIGS. 12a and 12b) or an Ry interface (as shown in FIG. 12) to WiFi SFF 1120, co-located with WIF 1118 and AR 1119. The combination of WIF 1118, AR 1119, and WiFi SFF 1120 (i.e., C-GW 1117) behaves as a virtual target POA.

C-GW 1117 (WIF 1118, AR 1119, and WiFi SFF 1120) processes the L2 control frame and may consult AAA 1112 in WiMAX CSN 1110 through an R3 interface. C-GW 1117 (WIF 1118, AR 1119, and WiFi SFF 1120) may maintain a higher layer registration context including security keys and data path information to maintain the IP session. Registration with C-GW 1117 (WIF 1118, AR 1119, and WiFi SFF 1120) results in pre-registration for WLAN AN 1115, which may have multiple POAs. When the MN attaches to a different target POA (e.g., AP), if C-GW 1117 (WIF 1118, AR 1119, and WiFi SFF 1120) already has the registration context, the registration context may be reused.

C-GW 1117 (WIF 1118, AR 1119, and WiFi SFF 1120) also constructs control messages to communicate with AP 1116. As it relates to exchanging these control messages, C-GW 1117 (WIF 1118, AR 1119, and WiFi SFF 1120) behaves like a virtual WLAN AP located in WLAN AN 1115 that is communicating with the MN. These control messages are equivalent to control messages used in a handover between APs within a single network. Therefore, the control messages may reuse the control messages exchanged between a source POA and a target POA within the same network to prepare for the handover of a MN within the same network.

Messages sent between C-GW 1117 and the MN may be tunneled to the MN using the WiMAX network. To AP 1116, C-GW 1117 acts like a virtual WLAN radio interface.

The MN may pre-register with WLAN AN 1115 using the same interface and transport mechanism as shown for proactive authentication.

An example handover decision process is as follows:
WLAN link preparation: Before a L3 handover occurs, the target link may perform preparation processes at L2, such as signal strength measurement, power level adjustment, and so forth.
A target POA (AP 1116) is selected. The MN may use the target interface to check the broadcast messages from the target POA to confirm that there is sufficient signal strength, for example.
WLAN AN 1115 may check with the target POA and AR 1119 to reserve radio resources needed for the MN to attach to WLAN AN 1115. The resources needed for the MN to operate in either active or idle mode may be assigned depending on whether the source radio was in an active or an idle mode.

Single radio handover execution. In single radio handover, the WiMAX link is disconnected and the WiFi radio is activated. The WiFi link (the target link) is established to complete the L3 handover. The association of the network layer address to the link layer address may change from the WiMAX link layer address to the WiFi link layer address, and future incoming packets are then routed to the WiFi radio.

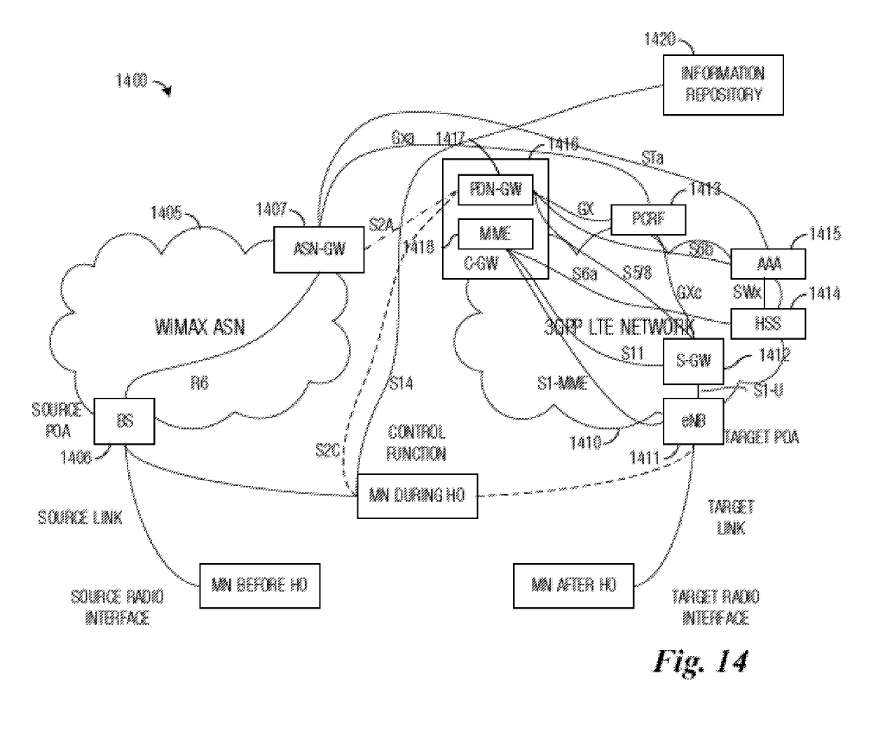

FIG. 14 illustrates a communications system 1400. Communications system 1400 includes a WiMAX ASN 1405, and a 3GPP LTE network 1410. With a 3GPP LTE compliant network, one option is to introduce the new C-GW functions into the 3GPP LTE network. The 3GPP LTE network already has standardized many network elements and reference points, which does not include the C-GW. An alternative is to define the C-GW functions in terms of existing 3GPP LTE functions and interfaces as much as possible. Example embodiments focus on enabling handover from a trusted network (such as a WiMAX network) by spreading the C-GW functions between PDN-GW and MME in the 3GPP LTE network.

WiMAX ASN 1405 includes a BS 1406 that serves as a POA, such as a source POA, for a MN. WiMAX ASN 1405 also includes an ASN-GW 1407, which may provide connectivity to 3GPP LTE network 1410.

3GPP LTE network 1410 includes an eNB 1411 that serves as a POA, such as a target POA, for the MN. 3GPP LTE network 1410 also includes a signaling gateway (S-GW) 1412 that may allow for signaling eNB 1411, a policy and charging rules function (PCRF) 1413 that may be used for policy management, a home subscriber server (HSS) 1414 that may be used for address management, an AAA 1415, and a C-GW 1416.

According to an example embodiment, C-GW 1416 implements the C-GW functionality with the combined functions of PDN-GW 1417 and MME 1418. To the MN, C-GW 1416 acts like a virtual target POA in the target network. To the target POA, C-GW 1416 acts like a virtual target radio interface to the MN. The functionality of C-GW 1416 is as described previously.

An information repository 1420, which may be implemented as an ANDSF in the 3GPP LTE network.

An S2a interface between PDN-GW 1417 in 3GPP LTE network 1410 and ASN-GW 1407 in WiMAX ASN 1405 is defined in the 3GPP LTE standards. An S14 interface between the MN and information repository 1420, an S5/8 interface between PDN-GW 1417 and S-GW 1412, an S11 interface between S-GW 1412 and MME 1418, an S1-U interface between the MN and S-GW 1412, an S1-MME interface between the MN and MME 1418, an S6a interface between PDN-GW 1417 and AAA 1415, an S6b interface between MME 1418 and HSS 1414, an SWx interface between HSS 1414 and AAA 1415, an STa interface between WiMAX ASN 1405 and AAA 1415, a Gx interface between PDN-GW 1417 and PCRF 1413, a Gxa interface between WiMAX ASN 1405 and PCRF 1413, and a Gxc interface between S-GW 1412 and PCRF 1413 are all defined in the 3GPP LTE standards. A R6 interface between BS 1406 and ASN-GW 1407 is defined in WiMAX standards.

Referencing the terminology presented in FIG. 4, a WiMAX to 3GPP LTE single radio handover may proceed as follows:

Network discovery: The MN queries information repository 1420, which may be implemented as an ANDSF. Alternatively, other implementations of information repository, such as a MIIS, are possible. Discovery of the information repository 1420 may be made through DHCP according to procedures as defined in IETF rfc6153. The queries from the MN and responses from information repository 1420 may use an S14 interface between the MN and information repository 1420. The queries and the responses may be carried in IP packets and may therefore use IP connectivity of the source link.

Information repository 1420 may provide the MN with information about available networks and handover policy. Information repository 1420 may also inform the MN whether 3GPP LTE networks of the available networks support single radio handover, the presence of PDN-GW 1417, as well as system information blocks of candidate POAs to allow the MN to perform radio measurements.

Pre-registration includes proactive authentication and establishing contexts (such as, user identity, security, resource information, and so on) at the target network (3GPP LTE network 1410). With help from C-GW 1416, the MN can perform network entry procedures towards the target network (3GPP LTE network 1410) while maintaining its connection with the source network (WiMAX ASN 1405).

The MN and the target network (3GPP LTE network 1410) perform proactive authentication via the source network (WiMAX ASN 1405). The exchange of handshake messages for authentication is as follows:

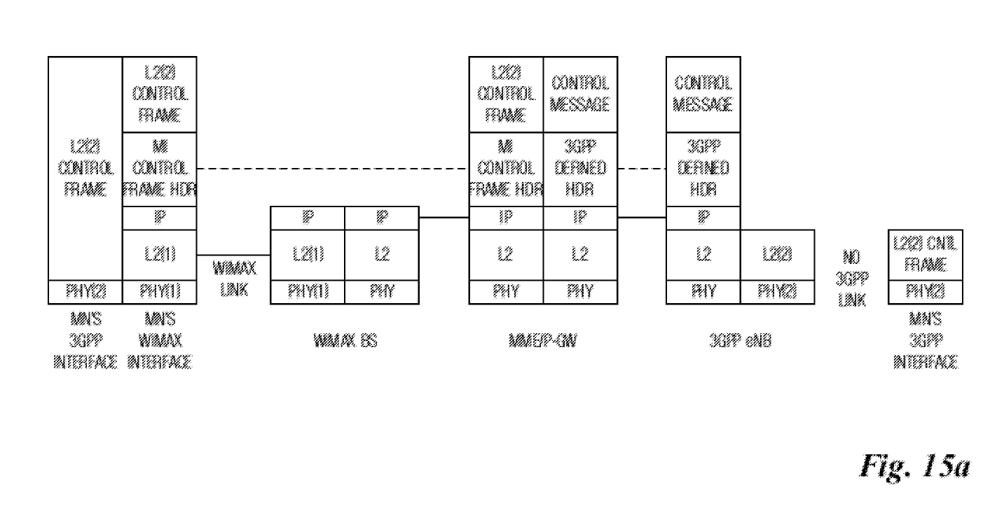

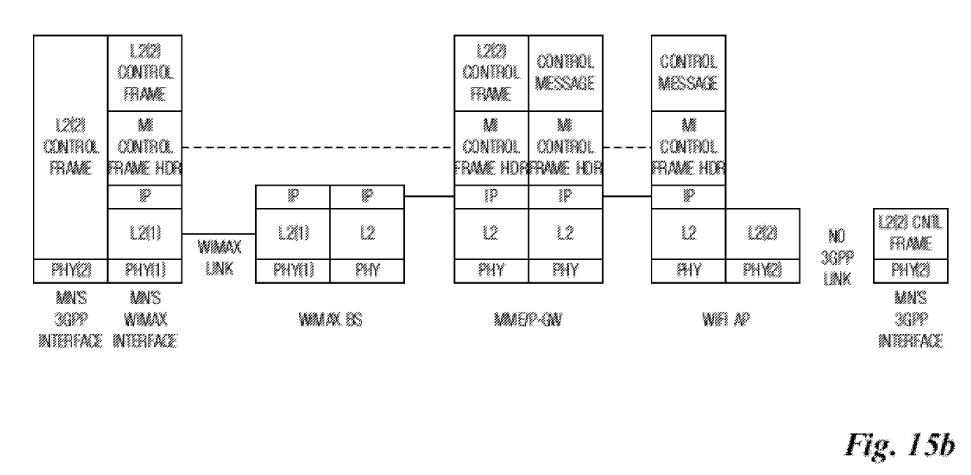

The handshake messages for authentication are exchanged between the MN and MME 1418, which may be serving as the authenticator. The handshake messages are L2 control frame messages in the target network (3GPP LTE network 1410), which could have been exchanged via the target link if the target link were available. When the target link is not available, the transport of the L2 control frame between the MN and MME 1418 is through the source network (WiMAX ASN 1405) using media independent control frames, whereas the 3GPP LTE defined interface or the media independent control frame may be used between MME 1418 and eNB 1411 as shown respectively in FIG. 15a and FIG. 15b.

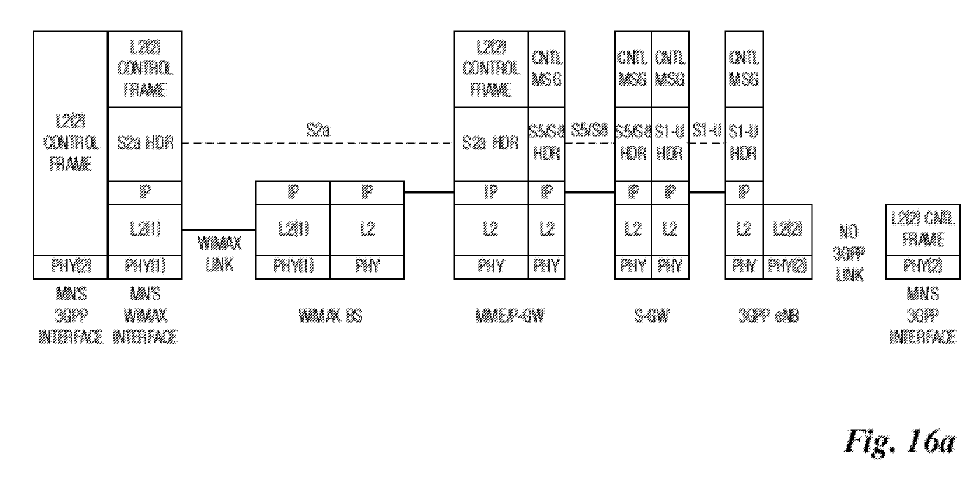

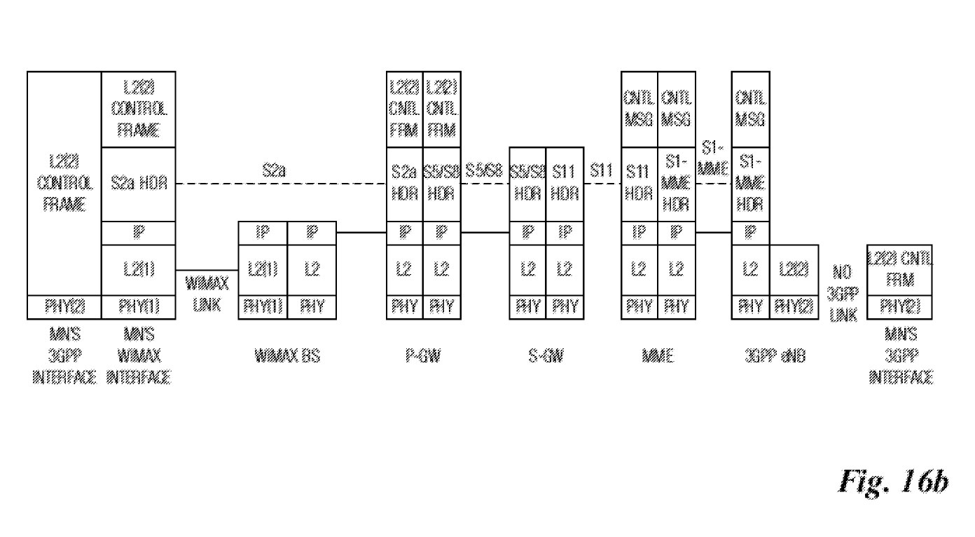

Alternatively, the S2a interface may be used between the MN and PDN-GW 1417. The S5/8, S1-U interface may be used between PDN-GW 1417 and eNB 1411 via S-GW 1412 as shown in FIG. 16a. The L2 control frame may also be transported between the MN and MME 1418 via PDN-GW 1417 and S-GW 1412 using the S2a, S5/S8, and S11 interfaces as shown in FIG. 16b.

As shown in FIGS. 15a, 15b, 16a, and 16b, a WiMAX link is illustrated as the source link and a missing 3GPP LTE link is illustrated as the target link. A 3GPP LTE radio L2 control frame may be transported using L2 transport to communicate with BS 1406 in a multiple radio handover scenario. However, in a single radio handover, the L2 control frame may be tunnel through the source link to PDN-GW 1417 using a MI control frame (as shown in FIGS. 15a and 15b). To reach MME 1418, PDN-GW 1417 may use the S5/S8 interface to forward the L2 control frame to S-GW 1412, while may then use the S11 interface to forward the L2 control frame to MME 1418. The combination of PDN-GW 1417 and MME 1418 (i.e., C-GW 1416) behaves as a virtual target POA.

C-GW 1416 (PDN-GW 1417 and MME 1418) processes the L2 control frame and may consult AAA 1415 in 3GPP LTE network 1410 through the S6b interface, whereas MME 1418 may consult HSS 1414 in 3GPP LTE network 1410 through the S6a interface. C-GW 1416 (PDN-GW 1417 and MME 1418) may maintain a higher layer registration context including security keys and data path information to maintain the IP session. Registration with C-GW 1416 (PDN-GW 1417 and MME 1418) results in pre-registration for 3GPP LTE network 1410, which may have multiple POAs. When the MN attaches to a different target POA (e.g., eNB), if C-GW 1416 (PDN-GW 1417 and MME 1418) already has the registration context, the registration context may be reused.

C-GW 1416 (PDN-GW 1417 and MME 1418) also constructs control messages to communicate with eNB 1411. As it relates to exchanging these control messages, C-GW 1416 (PDN-GW 1417 and MME 1418) behaves like a virtual 3GPP LTE eNB located in 3GPP LTE network 1410 that is communicating with the MN. These control messages are equivalent to control messages used in a handover between eNBs within a single network. Therefore, the control messages may reuse the control messages exchanged between a source POA and a target POA within the same network to prepare for the handover of a MN within the same network.

Messages sent between C-GW 1416 and the MN may be tunneled to the MN using the WiMAX network. To eNB 1411, C-GW 1416 acts like a virtual 3GPP LTE radio interface.

The MN may pre-register with 3GPP LTE network 1410 using the same interface and transport mechanism as shown for proactive authentication.

An example handover decision process is as follows:
3GPP LTE link preparation: Before a L3 handover occurs, the target link may perform preparation processes at L2, such as signal strength measurement, power level adjustment, and so forth.
A target POA (eNB 1411) is selected. The MN may use the target interface to check the broadcast messages from the target POA to confirm that there is sufficient signal strength, for example.
3GPP LTE network 1410 may check with the target POA and C-GW 1416 to reserve radio resources needed for the MN to attach to 3GPP LTE network 1410. The resources needed for the MN to operate in either active or idle mode may be assigned depending on whether the source radio was in an active or an idle mode.

Single radio handover execution. In single radio handover, the WiMAX link is disconnected and the 3GPP LTE radio is activated. The 3GPP LTE link (the target link) is established to complete the L3 handover. The association of the network layer address to the link layer address may change from the WiMAX link layer address to the 3GPP LTE link layer address, and future incoming packets are then routed to the 3GPP LTE radio.

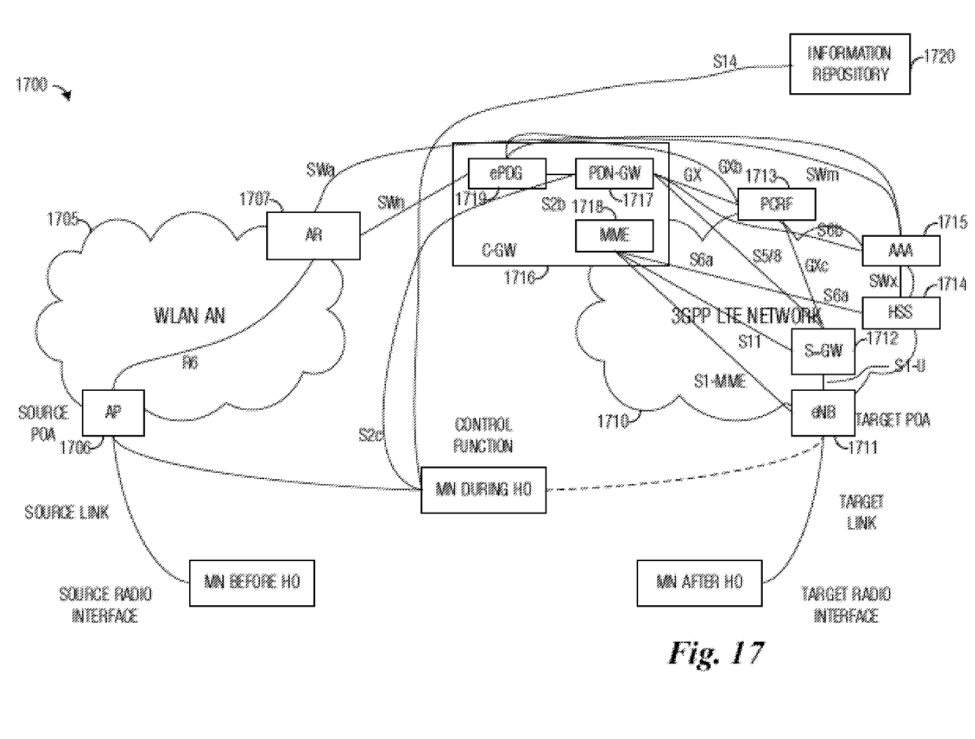

FIG. 17 illustrates a communications system 1700. Communications system 1700 includes a WLAN AN 1705, and a 3GPP LTE network 1710. With a 3GPP LTE compliant network, one option is to introduce the new C-GW functions into the 3GPP LTE network. The 3GPP LTE network already has standardized many network elements and reference points, which does not include the C-GW. An alternative is to define the C-GW functions in terms of existing 3GPP LTE functions and interfaces as much as possible. Example embodiments focus on enabling handover from an untrusted network (such as a WLAN network) by spreading the C-GW functions between PDN-GW, MME, and an evolved packet data gateway (ePDG) in the 3GPP LTE network.

WLAN AN 1705 includes an AP 1706 that serves as a POA, such as a source POA, for a MN. WLAN AN 1705 also includes an AR 1707, which may provide connectivity to 3GPP LTE network 1710.

3GPP LTE network 1710 includes an eNB 1711 that serves as a POA, such as a target POA, for the MN. 3GPP LTE network 1710 also includes a signaling gateway (S-GW) 1712 that may allow for signaling eNB 1711, a policy and charging rules function (PCRF) 1713 that may be used for policy management, a home subscriber server (HSS) 1714 that may be used for address management, an AAA 1715, and a C-GW 1716.

According to an example embodiment, C-GW 1716 implements the C-GW functionality with the combined functions of PDN-GW 1717, MME 1718, and an ePDG 1719 that may allow untrusted networks access. To the MN, C-GW 1716 acts like a virtual target POA in the target network. To the target POA, C-GW 1716 acts like a virtual target radio interface to the MN. The functionality of C-GW 1716 is as described previously.

An information repository 1720, which may be implemented as an ANDSF in the 3GPP LTE network.

An S2c interface between the MN and PDN-GW 1717, an S2b interface between ePDG 1719 and PDN-GW 1717, an S14 interface between the MN and information repository 1720, an S5/8 interface between PDN-GW 1717 and S-GW 1712, an S11 interface between S-GW 1712 and MME 1718, an S1-U interface between the MN and S-GW 1712, an S1-MME interface between the MN and MME 1718, an S6a interface between PDN-GW 1717 and AAA 1715, an S6b interface between MME 1718 and HSS 1714, an SWa interface between untrusted WLAN AN 1705 and AAA 1715, an SWn interface between untrusted WLAN AN 1705 and ePDG 1719, an SWm interface between ePDG 1719 and PDN-GW 1717, an SWx interface between HSS 1714 and AAA 1715, a Gx interface between PDN-GW 1717 and PCRF 1713, a Gxb interface between ePDG 1719 and PCRF 1713, and a Gxc interface between S-GW 1712 and PCRF 1713 are as defined in the 3GPP LTE standards.

Referencing the terminology presented in FIG. 4, a WLAN AN to 3GPP LTE single radio handover may proceed as follows:

Network discovery: The MN queries information repository 1720, which may be implemented as an ANDSF. Alternatively, other implementations of information repository, such as a MIIS, are possible. Discovery of the information repository 1720 may be made through DHCP according to procedures as defined in IETF rfc6153. The queries from the MN and responses from information repository 1720 may use an S14 interface between the MN and information repository 1720. The queries and the responses may be carried in IP packets and may therefore use IP connectivity of the source link.

Information repository 1720 may provide the MN with information about available networks and handover policy. Information repository 1720 may also inform the MN whether 3GPP LTE networks of the available networks support single radio handover, the presence of PDN-GW 1717 and/or ePDG 1719, as well as system information blocks of candidate POAs to allow the MN to perform radio measurements.

Pre-registration includes proactive authentication and establishing contexts (such as, user identity, security, resource information, and so on) at the target network (3GPP LTE network 1710). With help from C-GW 1716, the MN can perform network entry procedures towards the target network (3GPP LTE network 1710) while maintaining its connection with the source network (WLAN AN 1705).

The MN and the target network (3GPP LTE network 1710) perform proactive authentication via the source network (WLAN AN 1705). The exchange of handshake messages for authentication is as follows:

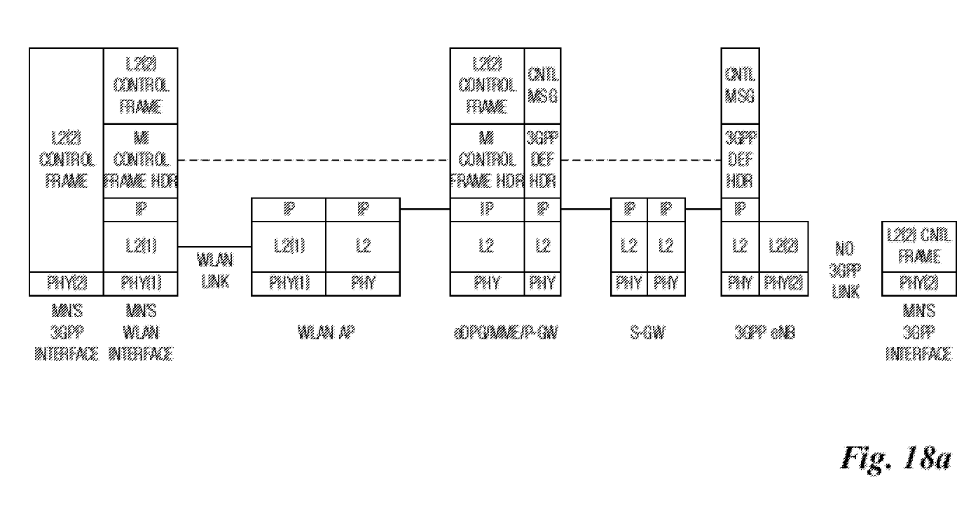

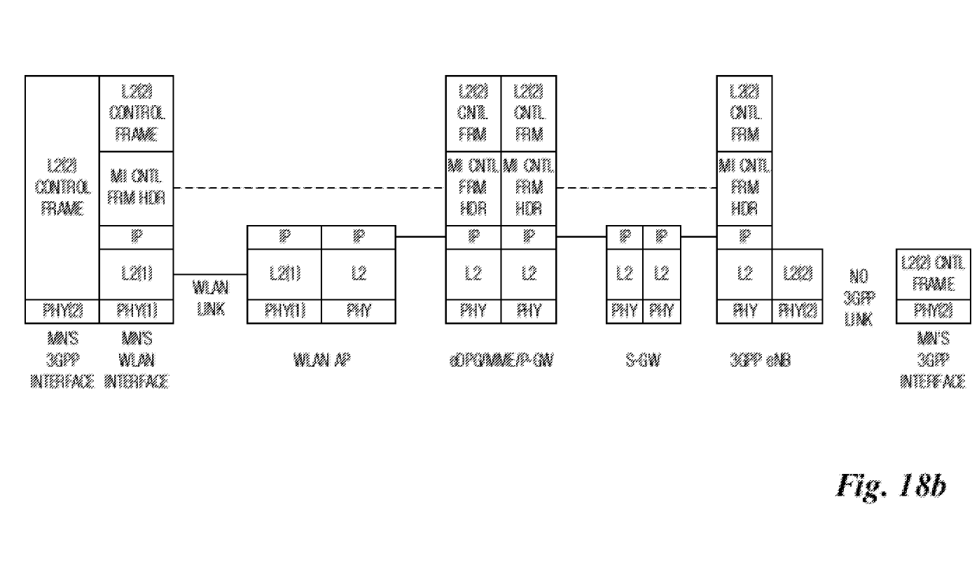

The handshake messages for authentication are exchanged between the MN and MME 1718, which may be serving as the authenticator. The handshake messages are L2 control frame messages in the target network (3GPP LTE network 1710), which could have been exchanged via the target link if the target link were available. When the target link is not available, the transport of the L2 control frame between the MN and MME 1718 is through the source network (WLAN AN 1705) using media independent control frames, whereas the 3GPP LTE defined interface or the media independent control frame may be used between MME 1718 and eNB 1711 as shown respectively in FIG. 18a and FIG. 18b.

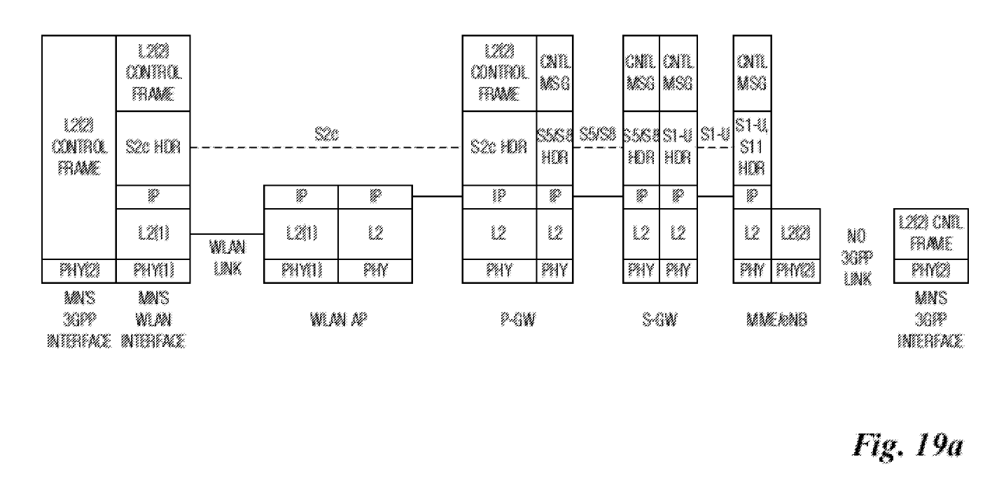

Alternatively, the S2c interface may be used between the MN and PDN-GW 1717 as shown in FIG. 19a, or the SWn interface may be used between AR 1707 and ePDG 1719 as shown in FIG. 19b. The S5/8 interface may be used between PDN-GW 1717 and S-GW 1712, the S1-U interface may be used between S-GW 1712 and eNB 1711, and the S11 interface may be used between S-GW 1712 and MME 1718.

As shown in FIGS. 18a, 18b, 19a, and 19b, a WLAN link is illustrated as the source link and a missing 3GPP LTE link is illustrated as the target link. A 3GPP LTE radio L2 control frame may be transported using L2 transport to communicate with eNB 1706 in a multiple radio handover scenario. However, in a single radio handover, the L2 control frame may be tunnel through the source link to PDN-GW 1717 using the S2c interface (as shown in FIGS. 18a and 18b). As shown in FIGS. 19a and 19b, the L2 control frame is tunneled to PDN-GW 1717 via AR 1707 and ePDG 1719 using the SWn interface between AR 1707 and ePDG 1719 and the S2b interface between ePDG 1719 and PDN-GW 1717. PDN-GW 1717 may then process the L2 control frame.

PDN-GW 1717 may then process the L2 control frame and may consult AAA 1715 in 3GPP LTE network 1710 through the S6b interface. Additionally, WLAN AN 1705 may communicate with AAA 1715 in 3GPP LTE network 1710 through the SWa interface.

PDN-GW 1717 may maintain a higher layer registration context including security keys and data path information to maintain the IP session. Registration with PDN-GW 1717 results in pre-registration for 3GPP LTE network 1710, which may have multiple POAs. When the MN attaches to a different target POA (e.g., eNB), if PDN-GW 1717 already has the registration context, the registration context may be reused.

PDN-GW 1717 also constructs control messages to communicate with eNB 1411 and with MME 1718 via S-GW 1712, using the S5/S8 interface between PDN-GW 1717 and S-GW 1712, the S1-U interface between S-GW 1712 and eNB 1711, and the S11 interface between S-GW 1712 and MME 1718.

As it relates to exchanging control messages between the MN and PDN-GW 1717, PDN-GW 1717 behaves like a virtual 3GPP LTE eNB located in 3GPP LTE network 1710 that is communicating with the MN. These control messages are equivalent to control messages used in a handover between eNBs within a single network. Therefore, the control messages may reuse the control messages exchanged between a source POA and a target POA within the same network to prepare for the handover of a MN within the same network.

Alternatively, the L2 control frame may be encapsulated by the WLAN AN 1705 to be sent using the SWn interface to ePDG 1719, which may encapsulate the L2 control frame using the S2b interface to send to PDN-GW 1717. ePDG 1719 and PDN-GW 1717 behave like a virtual target POA. ePDG 1719 and PDN-GW 1717 process the L2 control frame.

ePDG 1719 may consult AAA 1715 in 3GPP LTE network 1710 through the SWm interface. ePDG 1719 may consult PCRF 1713 using the Gxb interface. Messages from PDN-GW 1717 to the MN may be tunneled to the MN via WLAN AN 1705. To 3GPP LTE network 1710, PDN-GW 1717 acts like a virtual 3GPP LTE radio interface.

The MN may pre-register with 3GPP LTE network 1710 using the same interface and transport mechanism as described in proactive authentication. MME 1718 may consult HSS 1714 using the S6a interface.

An example handover decision process is as follows:
3GPP LTE link preparation: Before a L3 handover occurs, the target link may perform preparation processes at L2, such as signal strength measurement, power level adjustment, and so forth.
A target POA (eNB 1711) is selected. The MN may use the target interface to check the broadcast messages from the target POA to confirm that there is sufficient signal strength, for example.
3GPP LTE network 1710 may check with the target POA and PDN-GW 1717 and/or MME 1718 to reserve radio resources needed for the MN to attach to 3GPP LTE network 1710. The resources needed for the MN to operate in either active or idle mode may be assigned depending on whether the source radio was in an active or an idle mode.

Single radio handover execution. In single radio handover, the WLAN link is disconnected and the 3GPP LTE radio is activated. The 3GPP LTE link (the target link) is established to complete the L3 handover. The association of the network layer address to the link layer address may change from the WLAN link layer address to the 3GPP LTE link layer address, and future incoming packets are then routed to the 3GPP LTE radio.

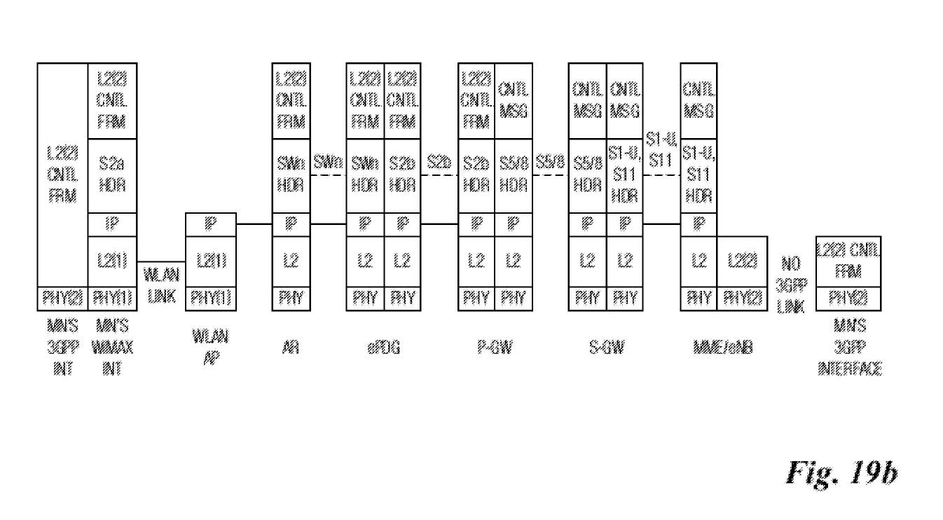

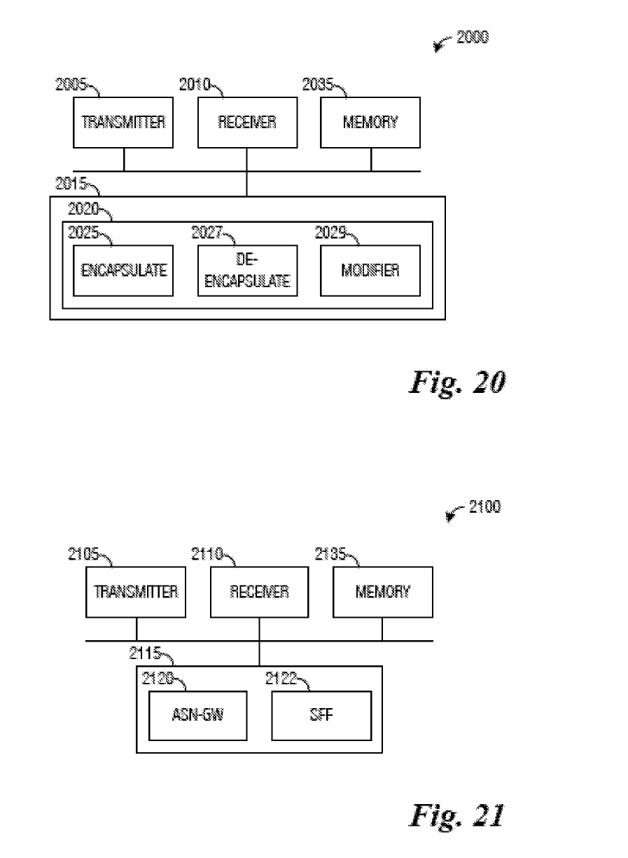

FIG. 20 provides an alternate illustration of a communications device 2000. Communications device 2000 may be an implementation of a C-GW. Communications device 2000 may be used to implement various ones of the embodiments discussed herein. As shown in FIG. 20, a transmitter 2005 is configured to transmit information and a receiver 2010 that is configured to receive information.

A transformation unit 2020 is configured to transform a first message into a second message. Transformation unit 2020 includes an encapsulate unit 2025 that is configured to encapsulate a payload with information to produce a message. As an example, encapsulate unit 2025 may add header information to the payload to produce the message. Transformation unit 2020 includes a de-encapsulate unit 2027 that is configured to extract a payload from a message. As an example, de-encapsulate unit 2027 may strip header information from the message to produce the header. Encapsulate unit 2025 and de-encapsulate unit 2027 may be used to convert messages from a first protocol to a second protocol (or a first format to a second format) to allow the transmission of a single message across multiple networks.

Transformation unit 2020 includes a modifier 2029 that is configured to modify a message and/or a payload of a message. As an example, modifier 2029 may modify source addresses and/or destination addresses of a message and/or a payload of message. A memory 1635 is configured to store messages, headers, format information, protocol information, and so forth.

The elements of communications device 2000 may be implemented as specific hardware logic blocks. In an alternative, the elements of communications device 2000 may be implemented as software executing in a processor, controller, application specific integrated circuit, or so on. In yet another alternative, the elements of communications device 2000 may be implemented as a combination of software and/or hardware.

As an example, receiver 2010 and transmitter 2005 may be implemented as a specific hardware block, while transformation unit 2020 (including encapsulate unit 2025, de-encapsulate unit 2027, and modifier 2029) may be software modules executing in a microprocessor (such as processor 2015) or a custom circuit or a custom compiled logic array of a field programmable logic array.

The above described embodiments of communications device 2000 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 4b, 4c, 4d, 4e, and 4f—is used to indicate the desired specific use (or non-use) of such terms.

FIG. 21 illustrates a C-GW 2100 for a WiMAX ASN. C-GW 2100 includes a transmitter 2105 that is configured to transmit information, a receiver 2120 that is configured to receive information, an ASN-GW 2120, a SFF 2122 and a memory 2135. In a WiMAX ASN, ASN-GW 2120 may have an external physical connection and operates basically as a gateway router. Messages entering and/or exiting the WiMAX ASN goes through ASN-GW 2120. SFF 2122 may serve as a proxy, serving to process incoming and/or outgoing messages for C-GW 2100. As an example, a message from a MN to a network entity in a target network may arrive at ASN-GW 2120 and then forwarded to SFF 2122, which processes the message and communicates with the network entity in the target network for the MN. ASN-GW 2120 and SFF 2122 may be implemented in a processor 2115 or a custom circuit or a custom compiled logic array of a field programmable logic array. ASN-GW 2120 and SFF 2122 may or may not be co-located.

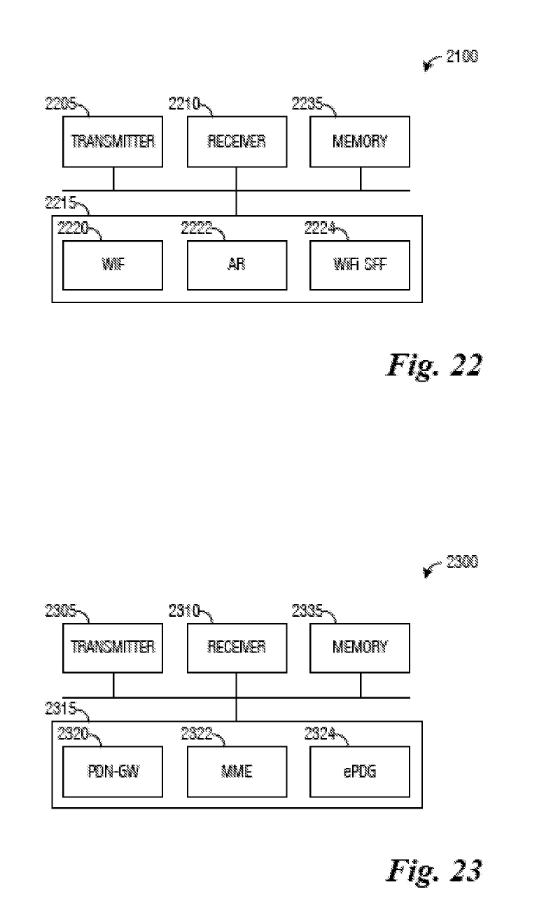

FIG. 22 illustrates a C-GW 2200 for a WLAN AN. C-GW 2200 includes a transmitter 2205 that is configured to transmit information, a receiver 2220 that is configured to receive information, a WIF 2220, an AR 2222, a WiFi SFF 2224, and a memory 2235. In a WLAN AN, WIF 2220 serve as an interface to an AAA server, while AR 2222 may have an external physical connection and operates basically as a gateway router. Messages entering and/or exiting the WLAN AN goes through AR 2222. WiFi SFF 2224 may serve as a proxy, serving to process incoming and/or outgoing messages for C-GW 2200. As an example, a message from a MN to a network entity in a target network may arrive at AR 2222 and then forwarded to WiFi SFF 2224, which processes the message and communicates with the network entity in the target network for the MN. WIF 2220, AR 2222, and WiFi SFF 2224 may be implemented in a processor 2215 or a custom circuit or a custom compiled logic array of a field programmable logic array. WIF 2220, AR 2222, and WiFi SFF 2224 may or may not be co-located.

FIG. 23 illustrates a C-GW 2300 for a 3GPP LTE network. C-GW 2300 includes a transmitter 2305 that is configured to transmit information, a receiver 2320 that is configured to receive information, a PDN-GW 2320, a MME 2322, an ePDG 2324, and a memory 2335. In a 3GPP LTE network, PDN-GW 2320 may have an external physical connection and operates basically as a gateway router. ePDG 2324 may allow access to untrusted networks. MME 2322 may serve as a proxy, serving to process incoming and/or outgoing messages for C-GW 2300. As an example, a message from a MN to a network entity in a target network may arrive at PDN-GW 2320 and then forwarded to MME 2322, which processes the message and communicates with the network entity in the target network for the MN. PDN-GW 2320, MME 2322, and ePDG 2324 may be implemented in a processor 2215 or a custom circuit or a custom compiled logic array of a field programmable logic array. PDN-GW 2320, MME 2322, and ePDG 2324 may or may not be co-located.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for controller operations, the method comprising:
receiving a first message from a mobile node, wherein the first message is transported in a first network;
transforming the first message into a second message, wherein the second message is to be transported in a second network; and
sending the second message to a point of access in the second network, wherein the point of access is a target point of access for the mobile node in a single radio handover.

2. The method of claim 1, further comprising:
receiving a third message from the point of access, wherein the third message is transported in the second network;
transforming the third message into a fourth message, wherein the fourth message is to be transported in the first network; and
sending the fourth message to the mobile node.

3. The method of claim 1, wherein transforming the first message comprises:
de-encapsulating the first message to extract a payload; and
encapsulating the payload to produce the second message.

4. The method of claim 3, wherein transforming the first message further comprises modifying the payload.

5. The method of claim 3, wherein the first message and the second message follow a media independent format.

6. The method of claim 3, wherein the first message and the second message follow different protocols.

7. The method of claim 1, wherein the first message comprises a pre-registration message, a target link preparation message, an authentication message, or combinations thereof.

8. A controller comprising:
a receiver configured to receive a first message from a mobile node, wherein the first message is transported in a first network;
a transformation unit coupled to the receiver, the transformation unit configured to operate as a gateway, and to transform the first message into a second message, wherein the second message is to be transported in a second network; and
a transmitter coupled to the transformation unit, the transmitter configured to transmit the second message to a point of access in the second network, wherein the point of access is a target point of access for the mobile node in a single radio handover.

9. The controller of claim 8, wherein the receiver is further configured to receive a third message from the point of access, wherein the third message is transported in the second network, wherein the transformation unit is further configured to transform the third message into a fourth message, wherein the fourth message is to be transported in the first network, and wherein the transmitter is further configured to transmit the fourth message to the mobile node.

10. The controller of claim 8, wherein the transformation unit comprises:
a de-encapsulate unit coupled to the receiver, the de-encapsulate unit configured to extract a payload from the first message; and
an encapsulate unit coupled to the transmitter and to the de-encapsulate unit, the encapsulate unit configured to encapsulate the payload to produce the second message.

11. The controller of claim 10, wherein the transformation unit further comprises a modifier coupled to the de-encapsulate unit and to the encapsulate unit, the modifier configured to modify the payload.

12. The controller of claim 10, wherein the first message and the second message follow a media independent format.

13. The controller of claim 10, wherein the first message and the second message follow different protocols.

14. A controller comprising:
a receiver configured to receive a first message from a mobile node, wherein the first message is transported in a first network;
a gateway coupled to the receiver, the gateway configured to transform the first message into a second message, wherein the second message is to be transported in a second network;
a proxy unit coupled to the receiver, the proxy unit configured to process the second message for transport in the second network; and
a transmitter coupled to the gateway and to the proxy unit, the transmitter configured to send the second message on the second network.

15. The controller of claim 14, wherein the controller is coupled to a WiMAX compliant network.

16. The controller of claim 15, wherein the gateway comprises a WiMAX access service network gateway.

17. The controller of claim 15, wherein the proxy unit comprises a signal forwarding function.

18. The controller of claim 15, wherein the proxy is further configured to de-encapsulate the first message to extract a payload, and to encapsulate the payload to produce the second message.

19. The controller of claim 14, wherein the controller is coupled to a Third Generation Partnership Project Long Term Evolution compliant network.

20. The controller of claim 19, wherein the gateway comprises a packet data network gateway.

21. The controller of claim 19, wherein the proxy unit comprises a mobility management entity.

22. The controller of claim 19, further comprising a packet gateway coupled to the receiver, the packet gateway configured to allow access to an untrusted network.

23. The controller of claim 22, wherein the packet gateway comprises an evolved packet data gateway.

24. The controller of claim 19, wherein the gateway is further configured to de-encapsulate the first message to extract a payload, and to encapsulate the payload to produce the second message.

25. A controller comprising:
a receiver configured to receive a first message from a mobile node, wherein the first message is transported in a first network;
a gateway coupled to the receiver, the gateway configured to transform the first message into a second message, wherein the second message is to be transported in a second network;
a proxy unit coupled to the receiver, the proxy unit configured to process the second message for transport in the second network;
an interoperability unit coupled to the receiver, the interoperability unit configured to authenticate messages; and
a transmitter coupled to the gateway and to the proxy unit, the transmitter configured to send the second message on the second network.

26. The controller of claim 25, wherein the controller is coupled to a wireless local area network access network.

27. The controller of claim 25, wherein the gateway comprises a wireless interworking function.

28. The controller of claim 25, wherein the proxy unit comprises an access router.

29. The controller of claim 25, wherein the interoperability unit comprises a signal forwarding function.

30. The controller of claim 25, wherein the gateway is further configured to de-encapsulate the first message to extract a payload, and to encapsulate the payload to produce the second message.

31. A method for mobile node operations, the method comprising:
performing a network discovery;
making a handover decision based on results from the network discovery;
preparing for a handover, wherein the preparing is performed through an intermediary and uses a single communications link; and
executing the handover.

32. The method of claim 31, wherein performing a network discovery comprises:
requesting information about candidate target networks; and
receiving the information about the candidate target networks.

33. The method of claim 32, wherein performing a network discovery further comprises making signal strength measurements for the candidate target networks.

34. The method of claim 31, wherein making a handover decision comprises determining if the handover is feasible based on selection parameters.

35. The method of claim 34, wherein the selection parameters comprises signal strength of candidate target networks, operating cost, operator policy, interference level of the candidate target networks, network load of the candidate target networks, historical performance of the candidate target networks, performance guarantees of the candidate target networks, or combinations thereof.

36. The method of claim 34, wherein making a handover decision further comprises selecting a target network from candidate target networks.

37. The method of claim 31, wherein preparing for a handover comprises performing pre-registration with a target network, wherein the pre-registration is performed through the intermediary and uses the single communications link.

38. The method of claim 37, wherein preparing for a handover further comprises establishing a link with the target network, wherein the establishing is performed through the intermediary and uses the single communications link.

39. A communications network comprising:
a point of access, the point of access configured to allow a mobile node to connect to the communications network and to access services of the communications network; and
a control gateway coupled to the point of access, the control gateway configured to serve as an intermediary for the mobile node to allow the communications node to communicate with the point of access in order to initiate a single radio handover with the point of access while the mobile node is connected to a source point of access of a source communications network, wherein communications between the mobile node and the point of access is over a communications link in the source communications network.

40. The communications network of claim 39, wherein the control gateway comprises:
a receiver configured to receive a first message from the mobile node, wherein the first message is transported in the source communications network;
a transformation unit coupled to the receiver, the transformation unit configured to transform the first message into a second message, wherein the second message is to be transported in the communications network; and
a transmitter coupled to the transformation unit, the transmitter configured to transmit the second message to the point of access in the communications network, wherein the point of access is a target point of access for the mobile node in a single radio handover.

41. The communications network of claim 40, wherein the receiver is further configured to receive a third message from the point of access, wherein the third message is transported in the communications network, wherein the transformation unit is further configured to transform the third message into a fourth message, wherein the fourth message is to be transported in the source communications network, and wherein the transmitter is further configured to transmit the fourth message to the mobile node.

42. The communications network of claim 40, wherein the transformation unit comprises:
a de-encapsulate unit coupled to the receiver, the de-encapsulate unit configured to extract a payload from the first message; and
an encapsulate unit coupled to the transmitter and to the de-encapsulate unit, the encapsulate unit configured to encapsulate the payload to produce the second message.

43. The communications network of claim 42, wherein the transformation unit further comprises a modifier coupled to the de-encapsulate unit and to the encapsulate unit, the modifier configured to modify the payload.
